(19) United States
(12) Patent Application Publication
(10) Pub. No.: US 2024/0059899 A1
(43) Pub. Date: Feb. 22, 2024

(54) COMPOSITE PARTICLES AND METHOD FOR PRODUCING COMPOSITE PARTICLES

(71) Applicant: DIC Corporation, Tokyo (JP)

(72) Inventors: Meng Li, Qingdao (CN); Takanori Watanabe, Sakura-shi (JP); Jianjun Yuan, Sakura-shi (JP); Shaowei Yang, Qingdao (CN); Xuan Li, Qingdao (CN); Wei Zhao, Qingdao (CN); Jian Guo, Qingdao (CN)

(73) Assignee: DIC Corporation, Tokyo (JP)

(21) Appl. No.: 18/271,681

(22) PCT Filed: Jan. 13, 2021
(86) PCT No.: PCT/CN2021/071385

§ 371 Date: Jul. 11, 2023

(51) Int. Cl. C09C 1/40; C09C 3/06

(52) U.S. Cl. CPC C09C 1/407; C09C 3/063; C01P 2002/52; C01P 2004/01; C01P 2004/20; C01P 2004/50; C01P 2004/61; C01P 2004/84

(57) ABSTRACT

The composite particles contain alumina particles with a card-house structure formed of three or more plate-like alumina particles that adhere to each other and an inorganic covering portion located on a surface of the plate-like alumina particles and containing a composite metal oxide.

### TECHNICAL FIELD

The present invention relates to composite particles and a method for producing the composite particles and particularly to composite particles having a covering portion on card-house type alumina particles.

### BACKGROUND ART

Various inorganic fillers, such as boron nitride and alumina, are known. These inorganic fillers are properly used in different applications. Alumina is more promising than boron nitride and the like due to its technical advantages, such as high hardness, high mechanical strength, and a high maximum operating temperature in an oxidizing atmosphere, as well as its lower prices.

Alumina particles are known to have various structures, such as granular, acicular, and plate-like, depending on the production method. In general, plate-like alumina particles with a higher aspect ratio have lower flowability due to their increased surface area and bulk density and have greater disadvantages from a practical standpoint.

PTL 1 discloses, as alumina with a specific shape, twin alumina particles with a particle size in the range of 0.5 to 10 μm in which two plate-like alumina particles are grown in an intrusively intersecting manner.

PTL 2 discloses particles in which whisker alumina composite oxide fine particles, such as boehmite, are aggregated in a plate-like shape into plate-like crystalline alumina composite oxide fine-particle aggregate forming a card-house structure. The plate-like crystalline alumina composite oxide fine-particle aggregate is characterized in that the whisker alumina composite oxide fine particles have an average length in the range of 2 to 100 nm and an average diameter in the range of 1 to 20 nm, and the composite oxide fine-particle aggregate has an average particle size in the range of 30 to 300 nm and an average thickness in the range of 2 to 50 nm. Thus, the particles of the fine-particle aggregate forming the card-house structure are also submicron fine alumina composite oxide particles.

PTL 3 discloses, as covered alumina particles, alumina particles covered with zirconia nanoparticles produced by covering the surface of the alumina particles 0.1 μm or more in average particle size with the zirconia nanoparticles 100 nm or less in average particle size.

### CITATION LIST

### Patent Literature

### [PTL 1]

Japanese Unexamined Patent Application Publication No. 7-207066

### [PTL 2]

Japanese Unexamined Patent Application Publication No. 2014-28716

### [PTL 3]

Japanese Unexamined Patent Application Publication No. 2005-306635

### SUMMARY OF INVENTION

### Technical Problem

PTL 1 discloses that it is possible to impart wear resistance to plastic or rubber, improve its strength and flame retardancy, increase the coefficient of friction of its surface, and provide a polymer with high transparency. However, there is no finding that such twin alumina particles have high flowability as a powder of composite particles with a covering portion containing a composite metal oxide.

With respect to PTL 2, there is also no finding that particles of such composite oxide fine-particle aggregate forming the card-house structure have high flowability as a powder of composite particles with a covering portion containing a composite metal oxide. Furthermore, the particles, for example, added to a binder or solvent as filler may impair processability due to an extreme increase in slurry viscosity, may make it difficult to form an efficient conduction path due to an increase in the number of interfaces, and may impair the original functions of alumina with high thermal conductivity.

PTL 3 discloses that dense sintered alumina with few pores, high toughness, and high flexural strength can be obtained, but does not describe alumina particles forming a card-house structure, and does not have any knowledge about the flowability of a powder of composite particles with a covering portion containing a composite metal oxide.

In view of such situations, it is an object of the present invention to provide composite particles with high flowability and a method for producing the composite particles.

### Solution to Problem

As a result of extensive studies to solve the above problems, the present inventors have completed the present invention by finding that composite particles of alumina particles with a card-house structure covered with an inorganic covering portion containing a composite metal oxide have high flowability. The present invention provides the following means to solve the above problems.
[1] Composite particles containing alumina particles with a card-house structure formed of three or more plate-like alumina particles that adhere to each other, and
an inorganic covering portion located on a surface of the plate-like alumina particles and containing a composite metal oxide.
[2] The composite particles according to [1], wherein the alumina particles have an average particle size in the range of 3 to 1000 μm.
[3] The composite particles according to [1], wherein the composite metal oxide contains a metal oxide of two or more metals selected from iron (Fe), titanium (Ti), zinc (Zn), nickel (Ni), cobalt (Co), and aluminum (Al).
[4] The composite particles according to [1], wherein the composite metal oxide contains a metal oxide of a metal selected from iron (Fe), titanium (Ti), zinc (Zn), nickel (Ni), and cobalt (Co) and another metal oxide different from the metal oxide, the other metal oxide being a metal oxide of a metal selected from iron (Fe), titanium (Ti), zinc (Zn), nickel (Ni), and cobalt (Co).
[5] The composite particles according to [1], wherein the alumina particles further contain silicon (Si) and/or germanium (Ge).
[6] The composite particles according to [5], wherein the alumina particles contain mullite in a surface layer.
[7] The composite particles according to [1], wherein the composite particles have an angle of repose of 50 degrees or less.
[8] A method for producing composite particles, firing a mixture containing an aluminum compound containing aluminum, a molybdenum compound containing molybdenum, and a shape control agent for controlling the shape of alumina particles to produce alumina particles with a card-house structure formed of three or more plate-like alumina particles that adhere to each other, and forming an inorganic covering portion containing a composite metal oxide on a surface of the plate-like alumina particles.
[9] The method for producing composite particles according to [8], wherein the shape control agent contains one or two or more selected from silicon, silicon compounds containing silicon, and germanium compounds containing germanium.
[10] The method for producing composite particles according to [8], wherein the mixture contains a molybdenum compound containing molybdenum, the molybdenum constituting 10% or less by mass in terms of MoO₃ per 100% by mass of all raw materials in terms of oxide.
[11] The method for producing composite particles according to [8], wherein the mixture contains an aluminum compound with an average particle size of 2 μm or more.
[12] The method for producing composite particles according to any one of [8] to [11], wherein the mixture further contains a potassium compound containing potassium.
[13] The method for producing composite particles according to [8], wherein the composite metal oxide contains a metal oxide of two or more metals selected from iron (Fe), titanium (Ti), zinc (Zn), nickel (Ni), cobalt (Co), and aluminum (Al).
[14] The method for producing composite particles according to [8], wherein the composite metal oxide contains a metal oxide of a metal selected from iron (Fe), titanium (Ti), zinc (Zn), nickel (Ni), and cobalt (Co) and another metal oxide different from the metal oxide, the other metal oxide being a metal oxide of a metal selected from iron (Fe), titanium (Ti), zinc (Zn), nickel (Ni), and cobalt (Co).
[15] The method for producing composite particles according to [8], wherein the step of forming the inorganic covering portion includes bringing the alumina particles into contact with a first metal inorganic salt containing at least one metal other than aluminum (Al) to convert a metal inorganic salt precipitated on the alumina particles into a composite metal oxide.
[16] The method for producing composite particles according to [8], wherein the step of forming the inorganic covering portion includes
a first conversion step of bring the alumina particles into contact with a first metal inorganic salt containing at least one metal other than aluminum (Al) to convert the first metal inorganic salt precipitated on the alumina particles into a metal oxide, and
a second conversion step of bringing the metal oxide and/or the alumina particles into contact with a second metal inorganic salt containing at least one other metal other than aluminum (Al) and different from the metal used in the first conversion step to convert the metal oxide and/or the second metal inorganic salt into a composite metal oxide.

### Advantageous Effects of Invention

The present invention can provide composite particles with high flowability.

### BRIEF DESCRIPTION OF DRAWINGS

FIG. 1 is an electron microscope image of composite particles produced in Example 1 as an example of the structure of composite particles according to an embodiment of the present invention.

FIG. 2 is a magnified image of the composite particles of FIG. 1.

FIG. 3 is a magnified image of the surface of the composite particles of FIG. 1.

FIG. 4 is an electron microscope image of composite particles produced in Example 4 as an example of the structure of composite particles according to an embodiment of the present invention.

FIG. 5 is a magnified image of the composite particles of FIG. 4.

FIG. 6 is a magnified image of the surface of the composite particles of FIG. 4.

FIG. 7 is an electron microscope image of composite particles produced in Example 5 as an example of the structure of composite particles according to an embodiment of the present invention.

FIG. 8 is a magnified image of the composite particles of FIG. 7.

FIG. 9 is a magnified image of the surface of the composite particles of FIG. 7.

### DESCRIPTION OF EMBODIMENTS

Embodiments of the present invention are described in detail below with reference to the accompanying drawings.

### [Composite Particles]

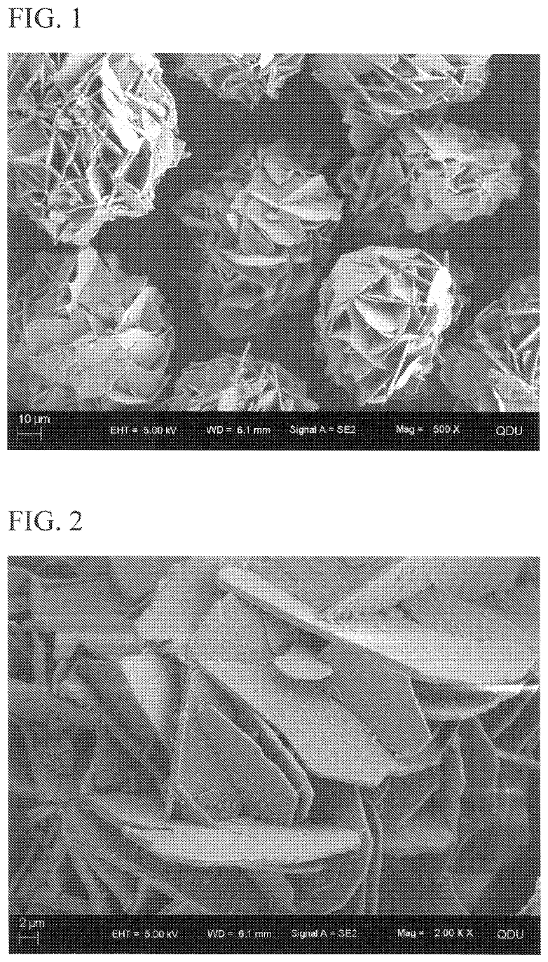

As illustrated in FIG. 1, composite particles according to the present embodiment contain alumina particles with a card-house structure formed of three or more plate-like alumina particles that adhere to each other and an inorganic covering layer located on the surface of the plate-like alumina particles and containing a composite metal oxide.

[Alumina Particles with Card-House Structure]

Alumina particles with a card-house structure have the card-house structure formed of three or more plate-like alumina particles that adhere to each other. The alumina particles with the card-house structure is hereinafter sometimes simply referred to as alumina particles. The term “plate-like” refers to a three-dimensional hexahedral plate shape, for example, with the shape of the two-dimensional projection plane being a typical quadrangle having four corners (quadrangular-plate-like) or with the shape of the two-dimensional projection plane being a polygon having five or more corners (hereinafter also referred to as a polygonal-plate-like). The alumina particles in the embodiments may contain potassium. The alumina particles in the embodiments may contain mullite and/or a germanium compound.

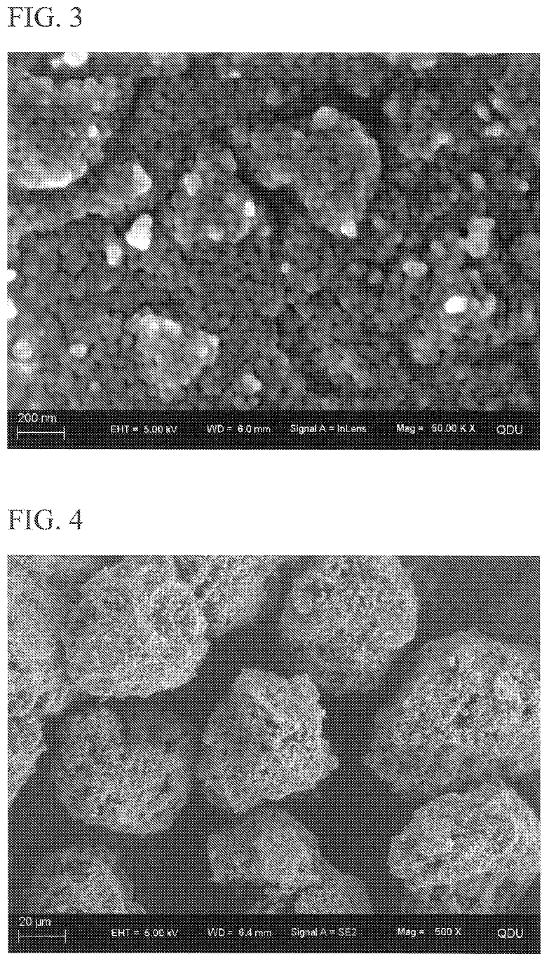

The morphology of the alumina particles can be examined with a scanning electron microscope (SEM). The card-house structure refers to, for example, a structure in which plate-like particles are not oriented and are intricately arranged. The term “card-house structure”, as used herein, refers to a structure formed of three or more plate-like alumina particles that adhere to each other. For example, three or more plate-like alumina particles intersect at two or more positions and are aggregated, and the plane directions of the intersecting plate-like alumina particles are disorderly arranged (see FIG. 2). The intersection positions may be any positions of the plate-like alumina particles. The disorderly arranged state means that the surfaces may intersect at any angle in any of the X-axis, Y-axis, and Z-axis directions. The “plate-like alumina particles” are described in detail later.

Depending on the required average particle size of the alumina particles used as filler (a filling material), the number of plate-like alumina particles in one alumina particle preferably ranges from, for example, 3 to 10000, particularly 10 to 5000, more particularly 15 to 3000, in terms of performance and manufacturability.

Plate-like alumina particles intersect when three or more plate-like alumina particles adhere and are aggregated by some interaction, for example, in the process of crystallization by firing. Consequently, they may appear intrusively. Firm adhesion of plate-like alumina particles increases the strength of the card-house structure.

The intersection means that two or more planes intersect at one position, and the planes may intersect at any position, diameter, or area. The number of directions of planes starting from the intersection position may be three or four or more.

The plane of each plate-like alumina particle in the card-house structure may have any maximum diameter, minimum diameter, and thickness. The plate-like alumina particles may have different sizes.

As described above, the plate-like alumina particles may be quadrangular-plate-like or polygonal-plate-like alumina particles. A single alumina particle may contain either quadrangular-plate-like alumina particles or polygonal-plate-like alumina particles alone or may contain both of them at any ratio.

In addition to the card-house structure, generally X-shaped particles in which two plate-like alumina particles intersect (sometimes referred to as twin alumina particles, see FIG. 1), generally T-shaped particles, generally L-shaped particles, and/or a single plate-like alumina particle may be contained in any state, provided that the effect of improving flowability is not impaired. As a matter of course, to achieve high flowability, the amount of these is preferably decreased, and the amount of alumina particles with the card-house structure formed of three or more plate-like alumina particles that adhere to each other is preferably 80% or more, more preferably 90% or more, still more preferably 95% or more, on a weight or number basis. The twin or single plate-like alumina particle content can be easily adjusted by typical classification, such as sieve classification or air classification.

Due to their specific structure, the alumina particles with the card-house structure have very high crushing strength and are not easily crushed by external stress. Thus, when blended with a binder or solvent, the alumina particles are less likely to cause poor flowability due to the anisotropy of the alumina particles themselves. Thus, it is possible to not only fully perform the original functions of the alumina particles but also, even if the alumina particles are used in combination with plate-like alumina particles, which tend to be oriented in the longitudinal direction, arrange the plate-like alumina particles in random directions. Consequently, the original characteristics of alumina, such as good heat conduction and mechanical strength, can be exhibited in the thickness direction as well as in the longitudinal direction.

Due to their specific structure, the alumina particles have high flowability as powder and make it possible to increase the discharge of supplying equipment, such as a hopper or feeder, used for mechanical transport in applications as industrial products. Although the alumina particles have voids inside in their unique structure and have a bulk specific gravity not much different from that of plate-like alumina particles, the alumina particles have higher sphericity and crushing strength as described above and are more resistant to breakage than plate-like alumina particles. Thus, it is presumed that the alumina particles have a large effect on the ease of transportation due to their rolling.

The alumina particles have the card-house structure. The card-house structure is described above. In the alumina particles, preferably, plate-like alumina particles have a quadrangular or higher polygonal shape, and at least part of adjacent alumina particles are in contact with each other. More preferably, plate-like alumina particles have a pentagonal or higher polygonal shape, and at least part of adjacent alumina particles are in contact with each other.

### [Crystal Form and α Crystallinity]

The alumina particles are formed of aluminum oxide, may have any crystal form, may be formed of transition alumina with a γ, δ, θ, or κ crystal form, or may contain hydrated alumina in transition alumina. Preferably, the alumina particles basically have an α crystal form in terms of higher mechanical strength or thermal conductivity.

The α crystallinity of the alumina particles can be determined by XRD measurement.

For example, the α crystallinity is determined from the peak intensity ratio of α-alumina to the baseline with a wide-angle X-ray diffraction (XRD) apparatus (Ultima IV manufactured by Rigaku Corporation) described later by mounting a sample on a sample holder and performing the measurement using Cu/Kα radiation at 40 kV/30 mA at a scanning speed of 1.0 degree/minute and in the scan range of 5 to 80 degrees. The α crystallinity depends on the firing conditions or the raw materials to be used. From the perspective of improving the crushing strength and flowability of the alumina particles, the α crystallinity is preferably 90% or more, more preferably 95% or more. The sample to be measured may be the alumina particles or plate-like alumina particles formed by breaking the card-house structure by machine processing.

### [Average Particle Size]

The alumina particles with the card-house structure may have any average particle size, provided that the alumina particles have the card-house structure, and preferably have an average particle size of 3 μm or more, more preferably 10 μm or more, in terms of particularly high flowability. The alumina particles with an excessively large size may result in poor appearance due to the exposure of the card-house structure in various applications, such as thermally conductive fillers and bright pigments. Thus, the average particle size is preferably 1000 μm or less, more preferably 300 μm or less, still more preferably 100 μm or less.

The numerical range may be 3 to 300 μm or 10 to 100 μm.

The term “the average particle size of alumina particles”, as used herein, refers to the median size D₅₀ on a volume basis calculated from the volumetric cumulative particle size distribution measured with a laser diffraction dry particle size distribution analyzer.

### [Maximum Particle Size]

The maximum particle size of the alumina particles on a volume basis (hereinafter sometimes referred to simply as “maximum particle size”) is, but not limited to, typically 3000 μm or less, preferably 1000 μm or less, more preferably 500 μm or less.

When used in combination with a solvent or a binder serving as a matrix, the alumina particles with a maximum particle size larger than the upper limit may undesirably protrude from the surface of the binder layer and give poor appearance in some end uses.

The average particle size and maximum particle size of the alumina particles in the embodiments are measured by a dry method in which the sizes of the alumina particles with the card-house structure formed of three or more plate-like alumina particles that adhere to each other are measured with a laser diffraction particle size distribution analyzer.

The average particle size and maximum particle size may be estimated by a wet method in which the sizes are measured with a laser diffraction/scattering particle size distribution analyzer in a sample containing the alumina particles dispersed in an appropriate solvent, more specifically, in a pure water medium containing sodium hexametaphosphate as a dispersion stabilizer.

### [Aspect Ratio of Plate-Like Alumina Particle]

Each plate-like alumina particle preferably has a polygonal-plate-like shape and an aspect ratio in the range of 2 to 500. The aspect ratio is the ratio of the particle size to the thickness. An aspect ratio of 2 or more is advantageous and preferable for the formation of the card-house structure while the performance characteristic of plate-like alumina particles is maintained. An aspect ratio of 500 or less is preferable for easy adjustment of the average particle size of the alumina particles and for the prevention of poor appearance due to the exposure of the card-house structure or for the prevention of the decrease in mechanical strength in various applications, such as thermally conductive fillers and bright pigments. The aspect ratio more preferably ranges from 5 to 300, still more preferably 7 to 100, particularly preferably 7 to 50. Plate-like alumina particles with an aspect ratio in the range of 7 to 100 have good thermal properties and optical properties, such as luminance, provide flowable alumina particles with the card-house structure, and are therefore practically preferred.

In the present specification, the thickness of plate-like alumina particles is the average thickness of at least 10 plate-like alumina particles measured with a scanning electron microscope (SEM).

The average particle size of plate-like alumina particles refers to the arithmetic mean of the maximum length of the distance between two points on the contour of the plate and is measured with a scanning electron microscope (SEM).

The average particle size of plate-like alumina particles is measured and calculated from the particle sizes of 100 plate-like alumina particles in an image taken with a scanning electron microscope (SEM).

The average particle size of plate-like alumina particles is determined, for example, by observing an alumina particle with a SEM and measuring the maximum length of plate-like alumina particles at the center of the alumina particle. Alternatively, the maximum length of one of the alumina particles obtained by air classification may be measured with a SEM. Alternatively, the card-house structure may be broken by machine processing under conditions where plate-like alumina particles are not broken, and the maximum length of a single particle thus obtained may be measured with a SEM.

The alumina particles with the card-house structure preferably have an average particle size in the range of 3 to 1000 μm, for example. Thus, plate-like alumina particles constituting the alumina particles preferably have, for example, a thickness in the range of 0.01 to 5 μm, an average particle size in the range of 0.1 to 500 μm, and an aspect ratio in the range of 2 to 500. The aspect ratio is the ratio of the particle size to the thickness. In the alumina particles to be used as a filling material, the plate-like alumina particles more preferably have a thickness in the range of 0.03 to 3 μm, an average particle size in the range of 0.5 to 100 μm, and an aspect ratio in the range of 5 to 300, still more preferably 7 to 200. The aspect ratio is the ratio of the particle size to the thickness.

### [Silicon and Germanium]

The alumina particles with the card-house structure preferably contain silicon (a silicon atom and/or an inorganic silicon compound) and/or germanium (a germanium atom and/or an inorganic germanium compound) and particularly preferably contain silicon and/or germanium on the surface of the plate-like alumina particles. In particular, for example, to effectively improve the affinity for a binder, it is preferable to locally contain silicon and/or germanium on the surface in a smaller amount than to contain silicon and/or germanium inside.

The silicon and germanium may be derived from silicon, a silicon compound, and a germanium compound used as a shape control agent in a method for producing alumina particles described later.

Silicon in the alumina particles may be silicon itself or silicon of a silicon compound. Plate-like alumina particles according to an embodiment may contain, as silicon or a silicon compound, at least one selected from the group consisting of mullite, Si, SiO₂, SiO, and aluminum silicates produced by a reaction with alumina. These substances may be contained in the surface layer. Mullite is described later.

The amount of silicon and/or germanium localized on the surface of plate-like alumina particles containing silicon and/or germanium can be determined, for example, by an analysis with an X-ray fluorescence spectrometer (XRF) or an analysis with an X-ray photoelectron spectroscopy (XPS).

In general, the X-ray fluorescence analysis (XRF) detects fluorescent X-rays generated by X-ray radiation and measures the wavelength and intensity for the quantitative analysis of the bulk composition of the material. In general, X-ray photoelectron spectroscopy (XPS) measures the kinetic energy of a photoelectron emitted from the surface of a sample by X-ray radiation and thereby analyzes the elemental composition of the surface of the sample. More specifically, the localization of silicon and/or germanium on and near the surface of plate-like alumina particles can be estimated from whether the [Si]/[Al] % (surface) or [Ge]/[Al] % (surface) determined from the XPS analysis result is higher than the [Si]/[Al] % (bulk, mole ratio) or [Ge]/[Al] % (bulk, mole ratio) determined from the XRF analysis result of the product. This is because a higher [Si]/[Al] % (surface) or [Ge]/[Al] % (surface) indicates a higher silicon and/or germanium content of the surface of plate-like alumina particles produced by the addition of silicon and/or germanium than the innermost portion of the plate-like alumina particles. Such an XRF analysis can be performed with Primus IV manufactured by Rigaku Corporation. Such an XPS analysis can be performed with Quantera SXM manufactured by ULVAC-PHI, Inc.

Plate-like alumina particles in the alumina particles preferably contain a silicon atom and/or an inorganic silicon compound localized on the surface thereof. In the XPS analysis, the mole ratio [Si]/[Al] of Si to Al is preferably 0.001 or more, more preferably 0.01 or more, still more preferably 0.02 or more, particularly preferably 0.1 or more.

The upper limit of the mole ratio [Si]/[Al] in the XPS analysis may be, but is not limited to, 0.5 or less, 0.4 or less, or 0.3 or less.

The mole ratio [Si]/[Al] of Si to Al of the alumina particles in the XPS analysis preferably ranges from 0.001 to 0.5, more preferably 0.01 to 0.4, still more preferably 0.02 to 0.3, particularly preferably 0.1 to 0.3. A mole ratio of Si to Al in the XPS analysis in the above range is preferred because the alumina particles with the card-house structure formed of plate-like alumina particles can be easily produced, and alumina particles thus produced can have high flowability and crushing strength. Furthermore, for example, the affinity for a binder can be improved.

A large number of silicon atoms and/or a large amount of inorganic silicon compound on the surface of plate-like alumina particles can not only make the surface properties of the alumina particles formed of the plate-like alumina particles more hydrophobic but also improve the affinity for organic compounds and various binders and matrices when the alumina particles are used as filler. Furthermore, silicon atoms and/or a silicon compound on the surface of the alumina particles can be involved as a reaction site in a reaction with a coupling agent, such as an organosilane compound, and can thereby easily modify the surface state of the alumina.

The XPS analysis shall be performed under the measurement conditions described later in examples or under compatible conditions where the same measurement results can be obtained.

In the alumina particles further containing silicon, Si is detected by the XRF analysis. The mole ratio [Si]/[Al] of Si to Al of the alumina particles according to an embodiment in the XRF analysis preferably ranges from 0.0003 to 0.1, more preferably 0.0005 to 0.08, still more preferably 0.005 to 0.05, still more preferably 0.005 to 0.01.

A mole ratio [Si]/[Al] in the XRF analysis in the above range is preferred because the alumina particles with the card-house structure formed of plate-like alumina particles can be easily produced, and alumina particles thus produced can have high flowability and crushing strength.

The alumina particles contain silicon derived from silicon or a silicon compound used in a method for producing the alumina particles. The silicon content in terms of silicon dioxide (SiO₂) per 100% by mass of the alumina particles in the XRF analysis preferably ranges from 0.01% to 8% by mass, more preferably 0.1% to 5% by mass, still more preferably 0.5% to 4% by mass, particularly preferably 0.5% to 2% by mass.

A silicon content in the above range is preferred because the alumina particles with the card-house structure formed of plate-like alumina particles can be easily produced, and alumina particles thus produced can have high flowability and crushing strength.

The XRF analysis shall be performed under the measurement conditions described later in examples or under compatible conditions where the same measurement results can be obtained.

### [Germanium]

The alumina particles may contain germanium. The alumina particles may contain germanium in the surface layer.

Depending on the raw materials to be used, the alumina particles may contain, as germanium or a germanium compound, at least one selected from the group consisting of compounds such as Ge, GeO₂, GeO, GeCl₂, GeBr₄, GelI₄, GeS₂, AlGe, GeTe, GeTe₃, GeSe, GeS₃As, SiGe, Li₂Ge, FeGe, SrGe, and GaGe and oxides thereof. The alumina particles may contain these substances in the surface layer.

The “germanium or germanium compound” contained in the alumina particles according to an embodiment may be a germanium compound of the same type as the “raw material germanium compound” used as a shape control agent in raw materials.

The alumina particles according to an embodiment may contain germanium or a germanium compound in the surface layer. Germanium or a germanium compound in the surface layer can reduce the wear of equipment. Alumina has a Mohs hardness of 9 and is classified as a very hard substance. On the other hand, among germanium and germanium compounds, for example, germanium dioxide (GeO₂) has a Mohs hardness of approximately 6, and the alumina particles according to an embodiment containing germanium or a germanium compound can reduce the wear of equipment. When the alumina particles according to an embodiment contain germanium or a germanium compound in the surface layer, the germanium or germanium compound on the surface rather than alumina of plate-like alumina particles comes into contact with equipment and can further reduce the wear of the equipment.

Germanium or a germanium compound in the surface layer of the alumina particles can significantly reduce the wear of equipment. The “surface layer”, as used herein, refers to 10 nm or less from the surface of plate-like alumina particles according to an embodiment. This distance corresponds to the detection depth of XPS. The surface layer containing germanium is a very thin layer of 10 nm or less. For example, in the case of germanium dioxide, an increased number of defects in the germanium dioxide structure on the surface and at the interface result in the hardness of the germanium dioxide lower than the original Mohs hardness (6.0) and result in a significant decrease in the wear of equipment compared with germanium dioxide with no or few structural defects.

The alumina particles preferably contain germanium or a germanium compound localized in the surface layer. The phrase “localized in the surface layer”, as used herein, refers to the mass of germanium or a germanium compound per unit volume in the surface layer higher than the mass of germanium or a germanium compound per unit volume in the region other than the surface layer. Germanium or a germanium compound localized in the surface layer can be identified by comparing the XPS surface analysis result with the XRF analysis result. Germanium or a germanium compound localized in the surface layer in a smaller amount than the germanium or germanium compound present not only in the surface layer but also in the region other than the surface layer (inner layer) can reduce the wear of equipment caused by the germanium or germanium compound on the same level as the germanium or germanium compound present in the surface layer and the inner layer.

The germanium content in terms of germanium dioxide (GeO₂) per 100% by mass of the alumina particles in the XRF analysis preferably ranges from 0.01% to 8% by mass, more preferably 0.1% to 5% by mass, still more preferably 0.5% to 4% by mass.

### [Mullite]

The alumina particles according to an embodiment may contain mullite in the surface layer. Mullite in the surface layer can reduce the wear of equipment. Alumina has a Mohs hardness of 9 and is classified as a very hard substance. By contrast, mullite has a Mohs hardness of 7.5. Thus, mullite in the surface layer of the alumina particles according to an embodiment rather than alumina in the alumina particles can come into contact with equipment and can reduce the wear of equipment.

Mullite in the surface layer of the alumina particles can significantly reduce the wear of equipment. “Mullite” optionally contained in the surface layer of the alumina particles is an Al—Si composite oxide represented by AlXSiYOz, wherein x, y, and z are not particularly limited. A preferred range includes Al₂Si₁O₅ to Al₆Si₂O₁₃, for example, Al_{2.85}Si₁O_{6.3}, Al₃Si₁O_{6.5}, Al_{3.67}Si₁O_{7.5}, Al₄Si₁O₈, and Al₆Si₂O₁₃. The alumina particles may contain at least one compound selected from the group consisting of Al_{2.85}Si₁O_{6.3}, Al₃Si₁O_{6.5}, Al_{3.67}Si₁O_{7.5}, Al₄Si₁O₈, and Al₆Si₂O₁₃ in the surface layer. The “surface layer”, as used herein, refers to 10 nm or less from the surface of plate-like alumina particles. This distance corresponds to the detection depth of XPS. The mullite surface layer is a very thin layer of 10 nm or less. An increased number of defects in mullite crystals on the surface and at the interface result in the hardness of the mullite surface layer lower than the original Mohs hardness of mullite (7.5) and result in a significant decrease in the wear of equipment compared with mullite with no or few crystal defects.

Mullite in the alumina particles is preferably localized in the surface layer. The phrase “localized in the surface layer”, as used herein, means that the mass of mullite per unit volume in the surface layer is larger than the mass of mullite per unit volume in the region other than the surface layer. Mullite localized in the surface layer can be identified by comparing the XPS surface analysis result with the XRF analysis result. Mullite localized in the surface layer in a smaller amount than mullite present not only in the surface layer but also in the region other than the surface layer (inner layer) can reduce the wear of equipment caused by mullite on the same level as mullite present in the surface layer and the inner layer.

Mullite in the surface layer may form a mullite layer or may coexist with alumina. Mullite and alumina may be in physical contact at the interface between mullite and alumina in the surface layer or may form a chemical bond, such as Si—O—Al. As compared with a combination of alumina and SiO₂, a combination containing alumina and mullite as essential components has a high degree of similarity in constituent atomic composition and, when a flux method is employed, easily form a chemical bond, such as Si—O—Al, based on it. Thus, alumina and mullite can be more firmly bonded and rarely separated. At the constant Si content, a combination containing alumina and mullite as essential components can reduce the wear of equipment for more extended periods and is therefore preferred. Although the technical advantages of a combination containing alumina and mullite as essential components are expected in a combination of alumina, mullite, and silica as well as a combination of alumina and mullite, the combination of alumina and mullite has slightly greater technical advantages.

Mullite on the surface of the alumina particles can be identified with a wide-angle X-ray diffraction (XRD) apparatus, such as Ultima IV manufactured by Rigaku Corporation.

For example, after an inorganic covering portion of composite particles is dissolved to expose card-house type alumina particles as described above, the sample is mounted on a sample holder 0.5 mm in depth, is charged flat under a constant load, is set in a wide-angle X-ray diffraction (XRD) apparatus, and is subjected to measurement using Cu/Kα radiation at 40 kV/40 mA at a scanning speed of 2 degree/minute and in the scan range of 10 to 70 degrees.

The presence or absence of mullite can be judged using the following equation, wherein A denotes the peak height of mullite at 2θ=26.2±0.2 degrees, B denotes the peak height of α-alumina on the (104) plane at 2θ=35.1±0.2 degrees, and C denotes the baseline at 2θ=30±0.2 degrees. For example, R is preferably 0.02 or more.

R=(A−C)/(B−C)
(R: the ratio of the peak height A of mullite to the peak height B of the (104) plane of α-alumina)

### [Molybdenum]

The alumina particles with the card-house structure contain molybdenum.

Molybdenum may be derived from a molybdenum compound used as a flux in a method for producing alumina particles described later.

Molybdenum has a catalytic function and an optical function. Molybdenum can be utilized to produce alumina particles with high flowability in a production method as described later.

The molybdenum may be, but is not limited to, molybdenum metal, molybdenum oxide, a partially reduced molybdenum compound, or a molybdate. Plate-like alumina particles may contain any of or a combination of possible polymorphs of molybdenum compounds and may contain α-MoO₃, β-MoO₃, MoO₂, MoO, and/or a molybdenum cluster structure.

Molybdenum may be contained in any form, for example, in the form of molybdenum adhering to the surface of plate-like alumina particles in the alumina particles with the card-house structure, in the form of molybdenum substituting for part of aluminum in the alumina crystal structure, or in the form of a combination thereof.

The molybdenum content in terms of molybdenum trioxide (MoO₃) per 100% by mass of the alumina particles in the XRF analysis is preferably 10% or less by mass and, after the firing temperature, the firing time, and the flux conditions are adjusted, preferably ranges from 0.001% to 8% by mass, more preferably 0.01% to 8% by mass, still more preferably 0.1% to 5% by mass. A molybdenum content of 10% or less by mass results in an α single crystal of alumina with improved quality and is therefore preferred.

The XRF analysis shall be performed under the measurement conditions described later in examples or under compatible conditions where the same measurement results can be obtained.

The amount of Mo on the surface of the alumina particles can be analyzed with the X-ray photoelectron spectroscopy (XPS).

### [Potassium]

The alumina particles with the card-house structure may contain potassium.

Potassium may be derived from potassium that can be used as a flux in a method for producing alumina particles described later.

Potassium can be utilized to efficiently produce alumina particles with high flowability in the method for producing alumina particles described later.

The potassium may be, but is not limited to, potassium metal, potassium oxide, or a partially reduced potassium compound.

Potassium may be contained in any form, for example, in the form of potassium adhering to the surface of plate-like alumina particles in the alumina particles with the card-house structure, in the form of potassium substituting for part of aluminum in the alumina crystal structure, or in the form of a combination thereof.

The potassium content in terms of potassium oxide (K₂O) per 100% by mass of the alumina particles in the XRF analysis is preferably 0.05% or more by mass, more preferably 0.05% to 5% by mass, still more preferably 0.1% to 3% by mass, particularly preferably 0.1% to 1% by mass. The alumina particles with a potassium content in the above range have the card-house structure, have an appropriate average particle size, and are therefore preferred. Furthermore, the alumina particles with a potassium content in the above range can have higher flowability and are preferred.

The XRF analysis shall be performed under the measurement conditions described later in examples or under compatible conditions where the same measurement results can be obtained.

### [Incidental Impurities]

The alumina particles may contain incidental impurities.

Incidental impurities may originate from metal compounds used in the production, may be present in the raw materials, and may be inevitably incorporated into the alumina particles in the production process. Although incidental impurities are essentially unnecessary, a minute amount of incidental impurities do not affect the characteristics of the alumina particles.

Examples of incidental impurities include, but are not limited to, magnesium, calcium, strontium, barium, scandium, yttrium, lanthanum, cerium, and sodium. These incidental impurities may be contained alone or in combination.

The incidental impurity content of the alumina particles is preferably 10000 ppm or less, more preferably 1000 ppm or less, still more preferably 10 to 500 ppm, of the mass of the alumina particles.

### [Other Atoms]

Other atoms refer to atoms that are intentionally added to the alumina particles to impart mechanical strength or an electrical or magnetic function without losing the advantages of the present invention.

Examples of other atoms include, but are not limited to, zinc, manganese, calcium, strontium, and yttrium. These other atoms may be used alone or in combination.

The other atom content of the alumina particles preferably 5% or less by mass, more preferably 2% or less by mass, of the mass of the alumina particles.

[Crushing Strength of Alumina Particles with Card-House Structure]

The alumina particles preferably have higher crushing strength because mechanical dispersion, such as compression or shearing, can destroy the card-house structure and impair the original flowability of the alumina particles. The crushing strength varies with the intersection position, number, and area of plate-like alumina particles and the thickness and aspect ratio of the plate-like alumina particles and also varies with the application.

From the practical aspect, the crushing strength preferably ranges from 1 to 100 MPa, more preferably 20 to 100 MPa, still more preferably 50 to 100 MPa. The crushing strength of the alumina particles can be measured with a fine particle crushing strength measuring apparatus NS-A100 manufactured by Nano Seeds Corporation or MCT-510 manufactured by Shimadzu Corporation, for example. The crushing strength S [Pa] is the average of ten values calculated using the following equation, wherein the crushing force F [N] is the difference between the crushing strength peak and the baseline (no force is applied).

S=2.8F/(π·D²)
D denotes the particle size [m].

As described above, the alumina particles have the card-house structure formed of three or more plate-like alumina particles that adhere to each other. The present inventors have found that the alumina particles appropriately containing a silicon atom and/or an inorganic silicon compound have higher crushing strength than the alumina particles not containing them. The crushing strength also depends on the silicon atom and/or inorganic silicon compound content. An appropriate increase in the silicon atom and/or inorganic silicon compound content results in particles with high flowability and crushing strength. The crushing strength can also be increased by employing particular production conditions in the production method. The crushing strength can be adjusted by the production conditions. For example, the firing temperature can be raised to increase the crushing strength of the alumina particles.

The alumina particles, which have the card-house structure formed of three or more plate-like alumina particles that adhere to each other, have an average particle size in the range of 1 to 1000 μm. More preferably, in the internal structure of the alumina particles, the three or more plate-like alumina particles adhering to each other in the card-house structure intersect at two or more positions and are aggregated, and the plane directions of the intersecting plate-like alumina particles are disorderly arranged.

Known twin alumina particles have conspicuous corners in their shapes, are less likely to roll than the alumina particles constituting the composite particles according to the present embodiments, and therefore do not originally have sufficient flowability as filler (a filling material). If alumina particles have the same card-house structure as the alumina particles constituting the composite particles according to the present embodiments, the alumina particles with a moderately larger average particle size have higher flowability. The alumina particles according to the present embodiments have particularly high flowability due to the synergistic effect of the card-house structure and their preferred average particle size.

### [Specific Surface Area]

A powder of the alumina particles typically has a specific surface area in the range of 50 to 0.001 m²/g, preferably 10 to 0.01 m²/g, more preferably 5.0 to 0.05 m²/g. These ranges result in an appropriate number of plate-like alumina particles constituting the card-house structure, satisfactory performance of the original functions of alumina, and high processability without a significant increase in viscosity when slurried.

The specific surface area can be measured according to JIS Z 8830: a BET one-point method (adsorption gas: nitrogen).

### [Porosity]

The alumina particles, which have the card-house structure formed of three or more plate-like alumina particles that adhere to each other, have voids inside. A high porosity rate tends to result in a uniform shape and improved flowability. Thus, the porosity is preferably 10% or more by volume, more preferably 30% or more by volume. A high porosity rate, however, results in a powder with low crushing strength. Thus, the porosity is preferably 90% or less by volume, more preferably 70% or less by volume. A porosity in these ranges results in an appropriate bulk specific gravity, unimpaired flowability, and good handleability. The porosity can be measured by a gas adsorption method or a mercury intrusion method according to JIS Z 8831.

Simply, the porosity can be estimated by mixing the alumina particles with a liquid curable compound, such as an epoxy compound or a (meth)acrylic monomer, curing the liquid curable compound, cutting and polishing a cross section, and observing the cross section with a SEM.

### [Inorganic Covering Portion]

The inorganic covering portion covers at least part of the surface of plate-like alumina particles and is preferably formed of an inorganic covering layer covering at least part of the surface of plate-like alumina particles. In other words, at least part of the surface of the composite particles is covered with the inorganic covering portion, preferably with an inorganic covering layer.

As described above, the inorganic covering portion is located on the surface of plate-like alumina particles. The phrase “on the surface of plate-like alumina particles”, as used herein, refers to the outside of the surface of the plate-like alumina particles. Thus, the inorganic covering portion on the outside of the surface of plate-like alumina particles is clearly distinguished from a surface layer containing mullite or germanium formed on the inside of the surface of the plate-like alumina particles.

Although an inorganic chemical species constituting the inorganic covering portion may be larger than the alumina particles, an inorganic chemical species smaller than the alumina particles is preferred because the inorganic covering portion in any amount (or of any thickness) can be easily formed for each purpose. The alumina particles on the order of micrometers and an inorganic chemical species of 150 nm or less may be combined. When an inorganic chemical species smaller than the alumina particles is used to form the inorganic covering portion on the outside of the surface of the alumina particles, a small amount of the inorganic chemical species may be used to form the inorganic covering portion on part of the alumina surface such that the base of the alumina particles can be clearly seen, or a large amount of the inorganic chemical species may be used to form the inorganic covering portion composed of stacked inorganic chemical species on the surface of the alumina particles such that the base of the alumina particles cannot be seen. The inorganic chemical species constituting the inorganic covering portion may have any shape and preferably has a spherical or polyhedral shape, for example, from the perspective that the base can be easily covered by closest packing with the minimum usage.

Composite particles according to the present invention are composed of the alumina particles and the inorganic covering portion. The alumina particles contain molybdenum, and the inorganic covering portion is composed of an inorganic chemical species. Composite particles according to the present invention have good characteristics that are not produced by a simple mixture of the alumina particles and the inorganic chemical species. When composite particles according to the present invention are composed of a combination of the alumina particles containing molybdenum on the order of micrometers and an unaggregated inorganic chemical species of 150 nm or less, for example, as a result of enhanced interaction between the alumina particles and the unaggregated inorganic chemical species due to intermolecular force or possibly due to a local chemical reaction, particularly excellent characteristics are exhibited, for example, better covering characteristics can be obtained, a more uniform inorganic covering portion can be easily formed, and the formed inorganic covering portion is rarely separated from the alumina particles. Molybdenum in the alumina particles is also expected to contribute to these. An independent inorganic chemical species on the order of nanometers, which can be produced, for example, by mechanically grinding an inorganic chemical species on the order of micrometers, reaggregates immediately and is therefore not easy to treat during use. The use of the alumina particles without molybdenum or an aggregated inorganic chemical species forms only a simple mixture and does not achieve the characteristics of the composite particles according to the present invention. Composite particles with higher covering efficiency can be more easily produced by a method for producing composite particles according to the present invention described later.

The inorganic covering portion according to the present embodiment contains a composite metal oxide and is preferably composed of the composite metal oxide. The term “composite metal oxide”, as used herein, refers to a metal oxide containing two or more metals or a plurality of metal oxides each containing one metal. The composite metal oxides can be broadly divided into (i) a mixture of a metal oxide containing two or more metals (a first compound) and a metal oxide of one metal (a second compound), (ii) a metal oxide containing two or more metals (a first compound), and (iii) a mixture of a metal oxide containing two or more metals (a first compound) and a metal oxide containing two or more metals (a second compound).

Examples of the mixture (i) include, but are not limited to, mixtures composed of a metal oxide of two or more metals selected from iron (Fe), titanium (Ti), zinc (Zn), nickel (Ni), cobalt (Co), and aluminum (Al) and a metal oxide of a metal selected from iron (Fe), titanium (Ti), zinc (Zn), nickel (Ni), and cobalt (Co). Specific examples of the mixture include aluminum·cobalt oxide and iron oxide, zinc·iron oxide and zinc oxide, and nickel·titanium oxide and nickel oxide.

The mixture (i) may contain a plurality of the metal oxides each containing two or more metals (the first compounds) or a plurality of metal oxides each containing a metal selected from iron (Fe), titanium (Ti), zinc (Zn), nickel (Ni), and cobalt (Co) (the second compounds). Specific examples of such a mixture include nickel·iron oxide, nickel oxide, and iron oxide.

Examples of the compound (ii) include, but are not limited to, metal oxides of two or more metals selected from iron (Fe), titanium (Ti), zinc (Zn), nickel (Ni), cobalt (Co), and aluminum (Al). Specific examples of the compound include zinc-titanium oxide.

Examples of the mixture (iii) include, but are not limited to, a mixture composed of a metal oxide of two or more metals selected from iron (Fe), titanium (Ti), zinc (Zn), nickel (Ni), cobalt (Co), and aluminum (Al) and another metal oxide different from the metal oxide, the other metal oxide being a metal oxide of two or more metals selected from iron (Fe), titanium (Ti), zinc (Zn), nickel (Ni), cobalt (Co), and aluminum (Al). Specific examples of the mixture include cobalt·iron oxide and aluminum·cobalt oxide, and titanium·cobalt oxide and aluminum·cobalt oxide.

The mixture (iii) may contain a plurality of (three or more) metal oxides each containing two or more metals selected from iron (Fe), titanium (Ti), zinc (Zn), nickel (Ni), cobalt (Co), and aluminum (Al).

The composite oxide constituting the inorganic covering portion may have any shape and may be spherical, acicular, polyhedral, discoidal, hollow, or porous particles. The average particle size of particles composed of a particulate composite oxide preferably ranges from, for example, 1 to 500 nm, more preferably 5 to 200 nm. Particles composed of a composite oxide may be crystalline or amorphous.

When the inorganic covering portion is an inorganic covering layer, the inorganic covering layer formed on the surface of plate-like alumina particles preferably has a thickness in the range of 20 to 400 nm, more preferably 30 to 300 nm, particularly preferably 30 to 200 nm.

The inorganic covering portion may be composed of one layer or a plurality of layers. In the inorganic covering portion composed of a plurality of layers, the layers may be composed of different materials.

In the inorganic covering portion, for example, composed of a first layer formed on the surface of the alumina particles and a second layer formed on the first layer, the first layer preferably has a thickness in the range of 10 to 200 nm, more preferably 15 to 150 nm, particularly preferably 15 to 100 nm. The second layer preferably has a thickness in the range of 10 to 200 nm, more preferably 15 to 150 nm, particularly preferably 20 to 150 nm.

### [Powder Flowability of Composite Particles]

Due to the unique structure of alumina constituting a powder of composite particles according to an embodiment and the preferred particular average particle size of the powder, the powder has higher flowability than plate-like alumina particles or twin alumina particles. To further improve the flowability, alumina particles constituting one unit of the card-house structure preferably have a spherical or approximately spherical volumetrically maximum surrounding surface that encloses all plate-like alumina particles constituting the alumina particles (see FIG. 1). If necessary, a lubricant or silica fine particles may be added to improve the flowability.

The powder flowability of composite particles can be determined by measuring the angle of repose according to JIS R9301-2-2, for example. The angle of repose is preferably 50 degrees or less, more preferably 40 degrees or less, because problems such as hopper bridging, feeding difficulties, uneven supply, and a low discharge rate are less likely to occur in mechanical transport with a feeder, a hopper, or the like.

### [Specific Surface Area of Powder of Composite Particles]

A powder of the composite particles typically has a specific surface area in the range of 0.01 to 100 m²/g, preferably 0.05 to 80 m²/g, more preferably 0.1 to 50 m²/g. In these ranges, when slurried, the powder has high processability without a significant increase in viscosity.

The specific surface area (m²/g) was determined by nitrogen adsorption and desorption by the BET one-point method using a flow specific surface area automatic measuring apparatus (FlowSorb II2300 manufactured by Shimadzu Corporation).

### [Crushing Strength of Composite Particles]

The composite particles according to the present embodiment preferably have higher crushing strength because mechanical dispersion, such as compression or shearing, can destroy the card-house structure and impair the original flowability of the alumina particles. The crushing strength varies with the intersection position, number, and area of plate-like alumina particles and the thickness and aspect ratio of the plate-like alumina particles and also varies with the application. From the practical aspect, the crushing strength preferably ranges from 1 to 200 MPa, more preferably 20 to 150 MPa, still more preferably 50 to 120 MPa.

The crushing strength of the composite particles (powder) can be measured with the measuring apparatus and measurement method used to measure the crushing strength of the alumina particles with the card-house structure.

As described above, the composite particles contain the alumina particles with the card-house structure formed of three or more plate-like alumina particles that adhere to each other. The present inventors have found that the alumina particles appropriately containing a silicon atom and/or an inorganic silicon compound have higher crushing strength than the alumina particles not containing them. The crushing strength also depends on the silicon atom and/or inorganic silicon compound content. An appropriate increase in the silicon atom and/or inorganic silicon compound content results in particles with high flowability and crushing strength. The crushing strength can also be increased by employing particular production conditions in the production method. The crushing strength can be adjusted by the production conditions. For example, the firing temperature can be increased to increase the crushing strength of the composite particles.

### [Organic Compound Layer on Surface of Composite Particles]

In one embodiment, the composite particles may have an organic compound layer on their surface. An organic compound constituting the organic compound layer is present on the surface of the composite particles and has the function of adjusting the surface physical properties of the composite particles. For example, the composite particles having an organic compound on their surface have an improved affinity for resin and can make the most of the functions of the alumina particles as filler.

Examples of the organic compound include, but are not limited to, organic silanes, alkylphosphonic acids, and polymers.

Examples of the organic silanes include alkyl trimethoxysilanes with an alkyl group having 1 to 22 carbon atoms, such as methyltrimethoxysilane, dimethyldimethoxysilane, ethyltrimethoxysilane, ethyltriethoxysilane, n-propyltrimethoxysilane, n-propyltriethoxysilane, iso-propyltrimethoxysilane, iso-propyltriethoxysilane, pentyltrimethoxysilane, and hexyltrimethoxysilane, 3,3,3-trifluoropropyltrimethoxysilane, (tridecafluoro-1,1,2,2-tetrahydrooctyl)trichlorosilane, phenyltrimethoxysilane, phenyltriethoxysilane, p-chloromethylphenyltrimethoxysilane, and p-chloromethylphenyltriethoxysilane.

Examples of the phosphonic acids include methylphosphonic acid, ethylphosphonic acid, propylphosphonic acid, butylphosphonic acid, pentylphosphonic acid, hexylphosphonic acid, heptylphosphonic acid, octylphosphonic acid, decylphosphonic acid, dodecylphosphonic acid, octadecylphosphonic acid, 2-ethylhexylphosphonic acid, cyclohexylmethylphosphonic acid, cyclohexylethylphosphonic acid, benzylphosphonic acid, phenylphosphonic acid, and dodecylbenzene phosphonic acid.

Suitable examples of the polymers include poly(meth)acrylates, more specifically, poly(methyl (meth)acrylate), poly(ethyl (meth)acrylate), poly(butyl (meth)acrylate), poly(benzyl (meth)acrylate), poly(cyclohexyl (meth)acrylate), poly(t-butyl (meth)acrylate), poly(glycidyl (meth)acrylate), and poly(pentafluoropropyl (meth)acrylate). Other examples of the polymers include general-purpose polystyrenes, poly(vinyl chloride), poly(vinyl acetate), epoxy resins, polyesters, polyimides, and polycarbonates.

These organic compounds may be contained alone or in combination.

The organic compound may be contained in any form and may be covalently bonded to alumina or may cover alumina or the material of the inorganic covering portion.

The organic compound content is preferably 20% or less by mass, more preferably 10% to 0.01% by mass, of the mass of the alumina particles. An organic compound content of 20% or less by mass is preferred because it is easy to exhibit the physical properties originating from the composite particles.

### [Method for Producing Composite Particles]

A method for producing composite particles according to an embodiment is exemplified below in detail. The method for producing composite particles according to the present embodiment is not limited to a method for producing composite particles described below.

The method for producing composite particles according to the present embodiment includes the steps of firing a mixture containing an aluminum compound containing aluminum, a molybdenum compound containing molybdenum, and a shape control agent for controlling the shape of alumina particles to produce alumina particles with a card-house structure formed of three or more plate-like alumina particles that adhere to each other and forming an inorganic covering portion containing a composite metal oxide on a surface of the plate-like alumina particles.

In the alumina particles constituting composite particles according to an embodiment, the average particle size, flowability, specific surface area, mechanical strength, and porosity of the alumina particles and the thickness and aspect ratio of plate-like alumina particles can be adjusted in a production method describes in detail. When the production method is, for example, a flux method, they can be adjusted by a molybdenum compound (and preferably a potassium compound) serving as a flux, the type of aluminum compound, the average particle size of the aluminum compound, the purity of the aluminum compound, the rate of use of at least one shape control agent selected from silicon, silicon compounds, and germanium compounds, the type of another shape control agent, the use ratio of the at least one shape control agent to the other shape control agent, the existential state of at least one shape control agent selected from silicon, silicon compounds, and germanium compounds and the aluminum compound, and the existential state of the other shape control agent and the aluminum compound.

The alumina particles may be produced by any method, provided that the alumina particles can have the card-house structure. However, it is undesirable to produce alumina with a specific structure referred to as the card-house structure from alumina with an existing structure by post-treatment because it requires a multistage production process and has low productivity. For example, from the perspective of productivity, it is preferable to adopt a method for producing alumina particles that can selectively form the card-house structure as a structure from an existing raw material for alumina, can easily incorporate molybdenum into the card-house structure, and simultaneously can easily incorporate potassium, silicon, and/or germanium into the card-house structure.

Thus, from the perspective of higher flowability and dispersibility and high productivity of the composite particles, the alumina particles are preferably produced by firing an aluminum compound in the presence of a molybdenum compound, at least one shape control agent selected from silicon, silicon compounds, and germanium compounds, and optionally another shape control agent.

Also from the perspective that almost all produced alumina particles can have the card-house structure and from the perspective of high productivity, the alumina particles are preferably produced by firing an aluminum compound in the presence of a molybdenum compound, a potassium compound, at least one shape control agent selected from silicon, silicon compounds, and germanium compounds, and optionally another shape control agent.

More specifically, a preferred method for producing alumina particles includes the step of firing an aluminum compound in the presence of a molybdenum compound and at least one shape control agent selected from silicon, silicon compounds, and germanium compounds (a firing step). The firing step may be the step of firing a mixture that is prepared in the step of preparing the mixture to be fired (a mixing step). The mixture preferably further contains a potassium compound. The mixture preferably further contains a metal compound described later. The metal compound is preferably an yttrium compound.

When an organic compound is used as a molybdenum compound or a silicon compound, an organic component is burned by firing. More specifically, the alumina particles are more easily formed by reacting a molybdenum compound with an aluminum compound at a high temperature to form aluminum molybdate and introducing molybdenum into the alumina particles when the aluminum molybdate is decomposed into alumina and molybdenum oxide at a higher temperature. Although molybdenum oxide sublimes, the molybdenum oxide may be recovered and reused. This production method is hereinafter referred to as a flux method. The flux method is described later in detail.

A shape control agent plays an important role in the growth of plate crystals. In a typical flux method using a molybdenum compound, molybdenum oxide reacts with an aluminum compound and forms aluminum molybdate, and a change in chemical potential during the decomposition of the aluminum molybdate acts as a driving force for crystallization. Thus, hexagonal bipyramidal polyhedral particles with a developed automorphic face (113) are formed. In a production method according to an embodiment, a shape control agent is localized near the surface of particles during the growth of α-alumina and significantly inhibits the growth of the automorphic face (113). This relatively promotes the growth of crystal orientation in the plane direction, grows the (001) or (006) plane, and can give a plate-like form. The use of a molybdenum compound as a flux facilitates the formation of alumina particles composed of plate-like alumina particles containing molybdenum with a high α crystallinity, particularly an α crystallinity of 90% or more.

It should be noted that the above mechanism is merely speculative, and another mechanism that can provide the advantages of the present invention is also within the technical scope of the present invention.

By utilizing a molybdenum compound in the alumina particles, alumina has a high α crystallinity and exhibits automorphism, and therefore has high dispersibility in the matrix, high mechanical strength, and high thermal conductivity.

Containing molybdenum, the alumina particles produced by the above production method have an isoelectric point of zeta potential closer to the acid side than typical alumina and have high dispersibility. Utilizing the characteristics of molybdenum in the alumina particles, the alumina particles can be applied to oxidation reaction catalysts and optical materials.

### [Method for Producing Alumina Particles by Flux Method]

Although the alumina particles may be produced by any method, from the perspective that alumina having a high α crystallinity at relatively low temperatures can be suitably controlled, the alumina particles can preferably be produced by the flux method utilizing a molybdenum compound.

More specifically, a preferred method for producing alumina particles includes the step of firing an aluminum compound in the presence of a molybdenum compound, at least one shape control agent selected from the group consisting of silicon, silicon compounds, and germanium compounds, and optionally another shape control agent.

The present inventors have found that, in a production method of firing a mixture of a molybdenum compound flux, a shape control agent, and an aluminum compound in the flux method, the size of a raw material aluminum compound, the amount of the molybdenum compound to be used (and the amount of potassium compound to be used when the potassium compound is used as a flux), and the amount of the shape control agent to be used are important factors in selectively producing alumina particles.

In the flux method, it is also preferable to use a molybdenum compound and a potassium compound as a flux.

A compound containing molybdenum and potassium serving as a flux can be produced, for example, in a firing process from a molybdenum compound and a potassium compound that are less expensive and easily available. The use of a molybdenum compound and a potassium compound as a flux is described below as an example of both the use of a molybdenum compound and a potassium compound as a flux and the use of a compound containing molybdenum and potassium as a flux.

In a method for producing alumina particles by firing a mixture of a molybdenum compound used as an essential flux, a shape control agent, and an aluminum compound, as compared with the use of only a molybdenum compound, such as molybdenum trioxide, when a molybdenum compound and a potassium compound are used as a flux or when a compound containing molybdenum and potassium is used as a flux, because the firing step is performed in the presence of the compound containing molybdenum and potassium, which is difficult to vaporize, the flux is not released to the outside of the system, and the firing environment is less deteriorated. Furthermore, because a compound containing molybdenum and potassium in a mixture of alumina particles and flux particles produced in a cooling step is often highly water-soluble, more molybdenum can be more easily removed from alumina.

The use of a molybdenum compound and a potassium compound as a flux or the use of a compound containing molybdenum and potassium as a flux and the cooling step can provide the alumina particles with the card-house structure at a very high yield without using strong grinding. This is probably because the flux occupies the space between the alumina particles with the card-house structure and acts like a spacer to prevent the fusion of the particles, and the flux can be easily removed in a post-treatment step.

From the perspective of preventing the fusion of the particles, the amount of flux to be used (the amount of molybdenum compound and potassium compound per 100% by mass of all raw materials in terms of oxide) is preferably 2% or more by mass in terms of Mo₂K₂O₇.

### [Mixing Step]

The mixing step includes mixing raw materials, such as an aluminum compound, a molybdenum compound, and a shape control agent, to prepare a mixture. The mixture may further contain a potassium compound. The mixture is described below.

### [Aluminum Compound]

The raw material aluminum compound is a raw material of the alumina particles and may be any compound that can be converted into alumina by heat treatment, for example, aluminum chloride, aluminum sulfate, basic aluminum acetate, aluminum hydroxide, boehmite, pseudo-boehmite, transition alumina (γ-alumina, δ-alumina, θ-alumina, etc.), α-alumina, or mixed alumina having two or more crystal phases. Aluminum hydroxide and/or transition alumina is preferred.

The aluminum compound may be composed of the aluminum compound alone or a composite of the aluminum compound and an organic compound. For example, an organic/inorganic composite produced by modifying the aluminum compound with an organosilane compound or a composite of the aluminum compound on which a polymer is adsorbed can be suitably used. Organic components in organic compounds can be burned by firing, and therefore these composites may have any organic compound content. From the perspective of efficiently producing the alumina particles with the card-house structure, the content is preferably 60% or less by mass, more preferably 30% or less by mass.

The aluminum compound may have any specific surface area. Although the specific surface area is preferably increased so that a molybdenum compound in the flux can effectively act, aluminum compounds with any specific surface area can be used as raw materials by adjusting the firing conditions or the amount of molybdenum compound to be used.

The shape of the alumina particles reflects the shape of the raw material aluminum compound in the flux method described in detail later. Any spherical structure, any amorphous structure, any structure with a high aspect ratio (wire, fiber, ribbon, tube, etc.), or any sheet may be used. To improve the powder flowability, a spherical aluminum compound is preferably used to form more spherical alumina particles.

In a method for producing alumina particles from an aluminum compound, the average particle size of the alumina particles also basically reflects the particle size of the raw material aluminum compound.

In the firing step in the flux method described later, it is presumed that plate-like alumina particles are crystallized in particles of a raw material aluminum compound, and three or more adjacent plate-like alumina particles intersect, adhere to each other, and form the card-house structure. It is therefore presumed that the average particle size of the alumina particles with the card-house structure mainly reflects the average particle size of the particles of the aluminum raw material.

Thus, the use of an aluminum compound with a smaller average particle size as a raw material tends to result in the formation of alumina particles with a smaller average particle size, and the use of an aluminum compound with a larger average particle size as a raw material tends to result in the formation of alumina particles with a larger average particle size.

Because the alumina particles constituting composite particles preferably have an average particle size in the range of 3 to 1000 μm, an aluminum compound with the same or almost the same average particle size as desired alumina particles with a particular average particle size in this range is preferably used.

In a method for producing alumina particles including the step of firing an aluminum compound in the presence of a molybdenum compound, at least one shape control agent selected from silicon, silicon compounds, and germanium compounds, and optionally another shape control agent, the alumina particles with the card-house structure can be produced, for example, by forming plate-like alumina particles, simultaneously bringing crystal planes of three or more of the plate-like alumina particles into contact with each other at a plurality of points, and crossing and fixing the three or more plate-like alumina particles. Thus, the plate-like alumina particles adhere to each other and fasten the card-house structure, so that the card-house structure is not easily destroyed (decomposed) by external stress, such as pressure. For example, the flux conditions under which plate-like alumina particles are formed have an influence on the crushing strength of the alumina particles with the card-house structure.

A smaller amount of molybdenum compound results in faster and more frequent adhesion of three or more plate-like alumina particles in aluminum compound particles, thus resulting in a stronger card-house structure with higher crushing strength.

According to the findings of the present inventors focusing on the flux method, the alumina particles with the card-house structure that have higher flowability and crushing strength can be produced, for example, under the following preferred conditions: 1) a raw material aluminum compound has an average particle size of 2 μm or more, particularly 4 μm or more, corresponding to the particle size of desired alumina particles, 2) the amount of molybdenum compound flux ranges from 0.005 to 0.236 mol in terms of molybdenum metal of the molybdenum compound per mol of aluminum metal of the aluminum compound, and 3) the amount of silicon compound as a shape control agent ranges from 0.003 to 0.09 mol in terms of silicon metal of the silicon compound per mol of aluminum metal of the aluminum compound.

In the flux method, in a method for producing alumina particles by firing a mixture of a molybdenum compound and a potassium compound serving as a flux, silicon or a silicon compound serving as a shape control agent, and an aluminum compound, 1) a raw material aluminum compound preferably has a particular average particle size, 2) the amount of molybdenum compound and potassium compound to be used is preferably limited to a particular range, and 3) the amount of silicon or silicon compound to be used is preferably limited to a particular range, because alumina particles having an average particle size in a particular range and having a card-house structure formed of three or more plate-like alumina particles that adhere to each other can be selectively formed.

The average particle size and shape of the alumina particles with the card-house structure can be adjusted in a grinding step and/or a classification step described later.

### [Molybdenum Compound]

As described later, a molybdenum compound functions as a flux in the α crystal growth of alumina. Examples of the molybdenum compound include, but are not limited to, molybdenum oxide and compounds containing an acid radical anion (MoOₓⁿ⁻) formed by bonding between molybdenum metal and oxygen.

Examples of the compounds containing the acid radical anion (MoOₓⁿ⁻) include, but are not limited to, molybdic acid, sodium molybdate, potassium molybdate, lithium molybdate, H₃PMo₁₂O₄₀, H₃SiMo₁₂O₄₀, NH₄Mo₇O₁₂, and molybdenum disulfide.

The molybdenum compound can contain sodium or silicon, and the molybdenum compound containing sodium or silicon serves as both a flux and a shape control agent.

Among the molybdenum compounds described above, molybdenum oxide is preferred in terms of cost. The molybdenum compounds may be used alone or in combination.

Containing potassium, potassium molybdate (K₂MoₙO₃ₙ₊₁, n=1 to 3) also functions as a potassium compound described later. In production methods according to embodiments, the use of potassium molybdate as a flux is equivalent to the use of a molybdenum compound and a potassium compound as a flux.

The amount of molybdenum compound to be used is preferably, but not limited to, in the range of 0.005 to 0.236 mol, more preferably 0.007 to 0.09 mol, still more preferably 0.01 to 0.04 mol, in terms of molybdenum metal of the molybdenum compound per mol of aluminum metal of the aluminum compound. The amount of molybdenum compound to be used is preferably in these ranges because the alumina particles with the card-house structure formed of plate-like alumina particles with a high aspect ratio and high dispersibility can be easily produced. When a molybdenum compound is used as a flux in the flux method, the alumina particles contain molybdenum. This can identify the method by which unknown alumina particles are produced.

When a molybdenum compound and a potassium compound are used as a flux, the amount of molybdenum compound to be used is not particularly limited, and the mole ratio of the molybdenum element of the molybdenum compound to the aluminum element of the aluminum compound (molybdenum element/aluminum element) preferably ranges from 0.01 to 3.0, more preferably 0.1 to 1.0, and, to suitably promote crystal growth with high productivity, still more preferably 0.30 to 0.70. The amount of molybdenum compound to be used is preferably in these ranges because the alumina particles with the card-house structure formed of plate-like alumina particles with a high aspect ratio and high dispersibility can be easily produced.

### [Potassium Compound]

When a molybdenum compound and a potassium compound are used as a flux, the potassium compound may be, but is not limited to, potassium chloride, potassium chlorite, potassium chlorate, potassium sulfate, potassium hydrogen sulfate, potassium sulfite, potassium hydrogen sulfite, potassium nitrate, potassium carbonate, potassium hydrogen carbonate, potassium acetate, potassium oxide, potassium bromide, potassium bromate, potassium hydroxide, potassium silicate, potassium phosphate, potassium hydrogen phosphate, potassium sulfide, potassium hydrogen sulfide, potassium molybdate, or potassium tungstate. Like the molybdenum compounds, the potassium compounds include isomers. Among these, preferred is potassium carbonate, potassium hydrogen carbonate, potassium oxide, potassium hydroxide, potassium chloride, potassium sulfate, or potassium molybdate, and more preferred is potassium carbonate, potassium hydrogen carbonate, potassium chloride, potassium sulfate, or potassium molybdate.

These potassium compounds may be used alone or in combination.

As described above, potassium molybdate, which contains molybdenum, also functions as a molybdenum compound. In production methods according to embodiments, the use of potassium molybdate as a flux is equivalent to the use of a molybdenum compound and a potassium compound as a flux.

As a potassium compound used during raw material preparation or produced in a reaction during the heating process in firing, a water-soluble potassium compound, for example, potassium molybdate, does not vaporize even in the firing temperature range and can be easily recovered by washing after the firing, thus decreasing the amount of molybdenum compound released to the outside of the firing furnace and significantly decreasing the production costs.

When a molybdenum compound and a potassium compound are used as a flux, the mole ratio of the molybdenum element of the molybdenum compound to the potassium element of the potassium compound (molybdenum element/potassium element) is preferably 5 or less, more preferably 0.01 to 3, and, to further decrease the production costs, still more preferably 0.5 to 1.5. When the mole ratio (molybdenum element/potassium element) is in the above range, the alumina particles can have a preferred particle size.

### [Silicon or Silicon Compound]

The use of silicon or a silicon compound as a shape control agent in a method for producing alumina particles is preferred because alumina particles thus produced have higher flowability. Silicon or a silicon compound plays an important role in the growth of plate-like crystals of alumina by firing an alumina compound in the presence of a molybdenum compound.

Silicon of a silicon compound is selectively adsorbed to the [113] plane of α crystals of alumina and suppresses the selective adsorption of a molybdenum oxide flux to the [113] plane. Thus, it is possible to form a plate-like form with a thermodynamically most stable dense hexagonal crystal structure in which the (001) or (006) plane is developed. It is presumed that a larger amount of silicon promotes crystallization on the (001) or (006) plane, and plate-like alumina particles thus formed have a smaller thickness.

An amount of silicon sufficient to selectively adsorb to the [113] plane of α crystals of alumina suppresses the selective adsorption of molybdenum oxide to the [113] plane. Thus, it is possible to form a plate-like form with a thermodynamically most stable dense hexagonal crystal structure in which the (001) or (006) plane is developed. It is presumed that a still larger amount of silicon can result in intersecting portions of plate-like alumina particles having a thermodynamically most stable dense hexagonal crystal structure as in the other portions and result in firm adhesion. Thus, an appropriately increased amount of silicon results in an increase in the crushing strength of the alumina particles with the card-house structure.

Any type of silicon or silicon compound may be used, and not only silicon atoms but also any known silicon compounds may be used. Specific examples include synthetic silicon compounds, such as metal silicon (silicon atoms), organosilane compounds, silicone resins, silica (SiO₂) fine particles, silica gel, mesoporous silica, SiC, and mullite; and natural silicon compounds, such as biosilica. Among these, preferred are organosilane compounds, silicone resins, and silica fine particles in terms of more uniform formation of a composite or mixture with an aluminum compound. These may be used alone or in combination.

When the silicon compound is an organosilicon compound, an organic component is burned by firing, and the organosilicon compound is converted into silicon atoms or an inorganic silicon compound and is contained in alumina particles. When the silicon compound is an inorganic silicon compound, silicon atoms or the inorganic silicon compound, which is not decomposed at high temperatures while firing, remains unchanged in firing and locally contained in the surface of plate-like alumina particles. From the above perspective, it is preferable to use silicon atoms and/or an inorganic silicon compound, which can increase the silicon atom content in a smaller amount if the molecular weight is the same.

The silicon or silicon compound may have any shape; for example, a spherical structure, an amorphous structure, a structure with a high aspect ratio (wire, fiber, ribbon, tube, etc.), or a sheet may be suitably used.

Although the amount of silicon or silicon compound to be used is not particularly limited, an amount of silicon or silicon compound sufficient to selectively adsorb to the [113] plane of α crystals of alumina is preferably used. Thus, the amount of silicon or silicon compound preferably ranges from 0.003 to 0.09 mol, more preferably 0.005 to 0.04 mol, still more preferably 0.007 to 0.03 mol, in terms of silicon metal of the silicon compound per mol of aluminum metal of the raw material aluminum compound.

When a molybdenum compound and a potassium compound are used as a flux, the amount of silicon compound to be added preferably ranges from 0.01% to 10% by mass, more preferably 0.03% to 7% by mass, still more preferably 0.03% to 3% by mass, of the amount of aluminum compound.

The amount of silicon compound to be used is preferably in these ranges because plate-like alumina particles have a high aspect ratio, and alumina particles tend to have high dispersibility. An insufficient amount of silicon compound tends to result in insufficiently suppressed adsorption of a molybdenum oxide flux to the [113] plane, plate-like alumina particles with a low aspect ratio, and nonuniform plate-like alumina particles. Furthermore, an insufficient amount of silicon compound tends to result in polyhedral alumina rather than alumina particles with the card-house structure and is therefore unfavorable. An excessively large amount of silicon compound is also unfavorable because excess silicon becomes an oxide by itself and forms crystals different from alumina, such as 3Al₂O₃·2SiO₂.

As described above, silicon or a silicon compound may be added to an aluminum compound and may be contained in an aluminum compound as an impurity.

In the above production method, silicon or a silicon compound may be added by any method, for example, by a dry blend method of directly adding and mixing a powder of the silicon or silicon compound, by mixing in a mixer, or by a method of adding the silicon or silicon compound dispersed in advance in a solvent or monomer.

Through the step of firing an aluminum compound in the presence of a molybdenum compound and a silicon compound, alumina particles with the card-house structure thus produced can easily contain a silicon atom and/or an inorganic silicon compound localized on and near the surface of plate-like alumina particles. According to the findings of the present inventors, the use of a silicon compound in preparation is an important factor for easily forming the card-house structure, and silicon atoms and/or an inorganic silicon compound localized on and near the surface of alumina particles formed by firing is also an important factor that causes a great change in the surface state of alumina, which originally has few active sites, and not only makes the most of the good characteristics of alumina by itself but also makes it possible to impart a better surface state together with a surface treatment agent through a reaction at the active sites serving as starting points.

### [Germanium Compound]

In combination with or instead of silicon or a silicon compound, a germanium compound may be used as a shape control agent. A germanium compound plays an important role in the growth of plate-like crystals of alumina by firing an alumina compound in the presence of a molybdenum compound.

Any raw material germanium compound may be used as a shape control agent, and known germanium compounds may be used. Specific examples of the raw material germanium compound include germanium metal, germanium dioxide, germanium oxide, germanium tetrachloride, and organic germanium compounds with a Ge—C bond. The raw material germanium compounds may be used alone or in combination. A germanium compound may be used in combination with another shape control agent without losing the advantages of the present invention.

The raw material germanium compound may have any shape; for example, a spherical structure, an amorphous structure, a structure with a high aspect ratio (wire, fiber, ribbon, tube, etc.), or a sheet may be suitably used.

The amount of germanium compound to be used is preferably, but not limited to, in the range of 0.002 to 0.09 mol, more preferably 0.004 to 0.04 mol, still more preferably 0.005 to 0.03 mol, in terms of germanium metal of the germanium compound per mol of aluminum metal of the raw material aluminum compound.

### [Another Shape Control Agent]

If necessary, a shape control agent other than those described above may be used in the alumina particles to adjust the flowability and dispersibility, mechanical strength, average particle size, and the aspect ratio of plate-like alumina particles, provided that the other shape control agent does not inhibit the formation of plate-like alumina particles using at least one shape control agent selected from silicon, silicon compounds, and germanium compounds. Like the other shape control agents, another shape control agent contributes to the growth of plate-like crystals of alumina by firing an alumina compound in the presence of a molybdenum compound.

Another shape control agent may exist in any state as long as it is in contact with an aluminum compound. For example, a physical mixture of a shape control agent and an aluminum compound or a composite containing a shape control agent uniformly or locally present on or under the surface of an aluminum compound is suitably used.

Another shape control agent may be added to an aluminum compound and may be contained in an aluminum compound as an impurity.

Another shape control agent may be added by any method, for example, by a dry blend method of directly adding and mixing a powder of the shape control agent, by mixing in a mixer, or by a method of adding the shape control agent dispersed in advance in a solvent or monomer.

Like at least one shape control agent selected from silicon, silicon compounds, and germanium compounds, another shape control agent is not limited to of any particular type, provided that the shape control agent can suppress the selective adsorption of molybdenum oxide to the [113] plane of α-alumina and can form a plate-like form while firing at high temperatures in the presence of a molybdenum compound. A metal compound other than molybdenum compounds and aluminum compounds is preferably used in terms of a higher aspect ratio of plate-like alumina particles, higher flowability and dispersibility of alumina particles, and higher productivity. Sodium atoms and/or a sodium compound is more preferably used.

Any sodium atoms and/or sodium compound may be used, and known sodium atoms and/or sodium compounds may be used. Specific examples include sodium carbonate, sodium molybdate, sodium oxide, sodium sulfate, sodium hydroxide, sodium nitrate, sodium chloride, and metallic sodium. Among these, sodium carbonate, sodium molybdate, sodium oxide, and sodium sulfate are preferably used in terms of industrial availability and handleability. Compounds containing sodium or a sodium atom may be used alone or in combination.

The sodium atom and/or sodium compound may have any shape; for example, a spherical structure, an amorphous structure, a structure with a high aspect ratio (wire, fiber, ribbon, tube, etc.), or a sheet may be suitably used.

The amount of sodium atom and/or sodium compound to be used is preferably, but not limited to, in the range of 0.0001 to 2 mol, more preferably 0.001 to 1 mol, in terms of sodium metal per mol of aluminum metal of the aluminum compound. The amount of sodium atom and/or sodium compound to be used is preferably in these ranges because alumina particles thus produced tend to have a high aspect ratio and high dispersibility.

### [Metal Compound]

A metal compound can have the function of promoting the growth of alumina crystals, as described later. A metal compound can be used in firing if desired. A metal compound that has the function of promoting the growth of α-alumina crystals is not essential for the production of composite particles.

The metal compound is not particularly limited and preferably includes at least one selected from the group consisting of the group II metal compounds and the group III metal compounds.

The group II metal compounds include magnesium compounds, calcium compounds, strontium compounds, and barium compounds.

The group III metal compounds include scandium compounds, yttrium compounds, lanthanum compounds, and cerium compounds.

These metal compounds refer to oxides, hydroxides, carbonates, and chlorides of metal elements. For example, the yttrium compounds include yttrium oxide (Y₂O₃), yttrium hydroxide, and yttrium carbonate. Among these, the metal compound is preferably an oxide of a metal element. These metal compounds include isomers.

Among these, preferred are metal compounds of third-row elements, metal compounds of fourth-row elements, metal compounds of fifth-row elements, and metal compounds of sixth-row elements, more preferred are metal compounds of fourth-row elements and metal compounds of fifth-row elements, and still more preferred are metal compounds of fifth-row elements. More specifically, magnesium compounds, calcium compounds, yttrium compounds, and lanthanum compounds are preferably used, magnesium compounds, calcium compounds, and yttrium compounds are more preferably used, and yttrium compounds are particularly preferably used.

The amount of metal compound to be added preferably ranges from 0.02% to 20% by mass, more preferably 0.1% to 20% by mass, of the amount of aluminum atom in the aluminum compound. The amount of metal compound to be added is preferably 0.02% or more by mass because the growth of α-alumina crystals containing molybdenum can be suitably promoted. The amount of metal compound to be added is preferably 20% or less by mass because the alumina particles can contain a small amount of impurities originating from the metal compound.

### [Yttrium]

When an aluminum compound is fired in the presence of an yttrium compound as a metal compound, crystals are suitably grown in the firing step, and α-alumina and a water-soluble yttrium compound are produced. The water-soluble yttrium compound tends to be localized on the surface of α-alumina particles, and, if necessary, the yttrium compound can be removed from the alumina particles by washing with water, alkaline water, or a hot liquid thereof.

When a molybdenum compound is used as a flux, although the amounts of the aluminum compound, molybdenum compound, and shape control agent to be used are not particularly limited, the following mixture 1-1) or 1-2) may be fired, wherein the amount of compound containing the molybdenum element is based on molybdenum trioxide (MoO₃), and the total amount of raw materials is set to 100% by mass in terms of oxide.
1-1) A mixture of
an aluminum compound containing the aluminum element: 80% or more by mass in terms of Al₂O₃, a molybdenum compound: 1.0% or more by mass in terms of MoO₃, and
a silicon compound containing silicon or the silicon element: 0.4% or more by mass in terms of SiO₂.
1-2) A mixture of
an aluminum compound containing the aluminum element: 80% or more by mass in terms of Al₂O₃,
a molybdenum compound: 1.0% or more by mass in terms of MoO₃, and
a germanium compound: 0.4% or more by mass in terms of GeO₂.

The mixture 1-1) or 1-2) can be used to more efficiently produce the alumina particles with the card-house structure.

As the common phenomenon caused by firing the mixture 1-1) or 1-2), crystals grow while at least part of the original form of the aluminum compound used as a raw material is retained in initial crystal growth. Thus, plate-like alumina particles are formed from a portion of the raw material aluminum compound as a starting point, and a card-house structure is formed of three or more plate-like alumina particles that adhere to each other.

In the 1-1), using the silicon compound containing silicon or the silicon element in an amount of 0.4% or more by mass in terms of SiO₂ and using a relatively large proportion thereof can suppress the deformation of the raw material aluminum compound and retain the shape of the aluminum compound used as a raw material.

In the 1-2), using the germanium compound in an amount of 0.4% or more by mass in terms of GeO₂ and using a relatively large proportion thereof can suppress the deformation of the raw material aluminum compound and retain the shape of the aluminum compound used as a raw material.

In the 1-1), from the perspective that the alumina particles with the card-house structure and with high flowability can be more easily produced, the amount of each raw material in the mixture per 100% by mass of all the raw materials in terms of oxide is preferably as described below.

In the 1-1), the amount of the aluminum compound is preferably 80% or more by mass, more preferably 85% to 99% by mass, still more preferably 85% to 95% by mass, in terms of Al₂O₃ per 100% by mass of all the raw materials in terms of oxide.

In the 1-1), the amount of the molybdenum compound is preferably 1.0% or more by mass, more preferably 2.0% to 15% by mass, still more preferably 4.0% to 10% by mass, in terms of MoO₃ per 100% by mass of all the raw materials in terms of oxide.

In the 1-1), the amount of the silicon compound containing silicon or the silicon element is preferably 0.4% or more by mass, more preferably 0.4% to 5.0% by mass, still more preferably 0.5% to 2.0% by mass, in terms of SiO₂ per 100% by mass of all the raw materials in terms of oxide.

In the 1-2), from the perspective that alumina particles with the card-house structure and with high flowability can be more easily produced, the amount of each raw material in the mixture per 100% by mass of all the raw materials in terms of oxide is preferably as described below.

In the 1-2), the amount of the aluminum compound is preferably 80% or more by mass, more preferably 85% to 99% by mass, still more preferably 85% to 95% by mass, in terms of Al₂O₃ per 100% by mass of all the raw materials in terms of oxide.

In the 1-2), the amount of the molybdenum compound is preferably 1.0% or more by mass, more preferably 2.0% to 15% by mass, still more preferably 4.0% to 10% by mass, in terms of MoO₃ per 100% by mass of all the raw materials in terms of oxide.

In the 1-2), the amount of the germanium compound is preferably 0.4% or more by mass, more preferably 0.4% to 5.0% by mass, still more preferably 0.5% to 2.0% by mass, in terms of GeO₂ per 100% by mass of all the raw materials in terms of oxide.

When a molybdenum compound and a potassium compound are used as a flux, although the amounts of the aluminum compound, molybdenum compound, potassium compound, and shape control agent to be used are not particularly limited, the following mixture 2-1) or 2-2) may be fired, wherein the amount of compound containing the molybdenum element and the potassium element or the amount of a molybdenum compound containing the molybdenum element and a potassium compound containing the potassium element is based on potassium molybdate (MO₂K₂O₇), and the total amount of raw materials is set to 100% by mass in terms of oxide.
2-1) A mixture of
an aluminum compound containing the aluminum element: 10% or more by mass in terms of Al₂O₃,
the molybdenum compound and the potassium compound: 50% or more by mass in terms of Mo₂K₂O₇, and a silicon compound containing silicon or the silicon element: 0.3% or more by mass in terms of SiO₂.
2-2) A mixture of
an aluminum compound containing the aluminum element: 50% or more by mass in terms of Al₂O₃,
the molybdenum compound and the potassium compound: 30% or less by mass in terms of Mo₂K₂O₇, and
a silicon compound containing silicon or the silicon element: 0.01% or more by mass in terms of SiO₂.

The mixture 2-1) or 2-2) can be used to more efficiently produce the alumina particles with the card-house structure.

As the common phenomenon caused by firing the mixture 2-1) or 2-2), crystals grow while at least part of the original form of the aluminum compound used as a raw material is retained in initial crystal growth. Thus, plate-like alumina particles are formed from a portion of the raw material aluminum compound as a starting point, and a card-house structure is formed of three or more plate-like alumina particles that adhere to each other.

In the 2-1), using the silicon compound containing silicon or the silicon element in an amount of 0.3% or more by mass in terms of SiO₂ and using a relatively large proportion thereof can suppress the deformation of the raw material aluminum compound and retain the shape of the aluminum compound used as a raw material.

In the 2-2), using the molybdenum compound and the potassium compound in an amount of 30% or less by mass in terms of Mo₂K₂O₇ and using a relatively small proportion thereof can suppress the deformation of the raw material aluminum compound and retain the shape of the aluminum compound used as a raw material.

In the 2-1), from the perspective that alumina particles with the card-house structure and with high flowability can be more easily produced, the amount of each raw material in the mixture per 100% by mass of all the raw materials in terms of oxide is preferably as described below.

In the 2-1), the amount of the aluminum compound is preferably 10% or more by mass, more preferably 10% to 70% by mass, still more preferably 20% to 45% by mass, particularly preferably 25% to 40% by mass, in terms of Al₂O₃ per 100% by mass of all the raw materials in terms of oxide.

In the 2-1), the amount of the molybdenum compound and the potassium compound is preferably 50% or more by mass, more preferably 50% to 80% by mass, still more preferably 55% to 75% by mass, still more preferably 60% to 70% by mass, in terms of Mo₂K₂O₇ per 100% by mass of all the raw materials in terms of oxide.

In the 2-1), the amount of the silicon compound containing silicon or the silicon element is preferably 0.3% or more by mass, more preferably 0.3% to 5% by mass, still more preferably 0.4% to 3% by mass, in terms of SiO₂ per 100% by mass of all the raw materials in terms of oxide.

In the 2-2), from the perspective that alumina particles with the card-house structure and with high flowability can be more easily produced, the amount of each raw material in the mixture per 100% by mass of all the raw materials in terms of oxide is preferably as described below.

In the 2-2), the amount of the aluminum compound is preferably 50% or more by mass, more preferably 50% to 96% by mass, still more preferably 60% to 95% by mass, particularly preferably 70% to 90% by mass, in terms of Al₂O₃ per 100% by mass of all the raw materials in terms of oxide.

In the 2-2), the amount of the molybdenum compound and the potassium compound is preferably 30% or more by mass, more preferably 2% to 30% by mass, still more preferably 3% to 25% by mass, particularly preferably 4% to 10% by mass, in terms of Mo₂K₂O₇ per 100% by mass of all the raw materials in terms of oxide.

In the 2-2), the amount of the silicon compound containing silicon or the silicon element is preferably 0.01% or more by mass, more preferably 0.01% to 5% by mass, still more preferably 0.05% to 3% by mass, particularly preferably 0.15% to 3% by mass, in terms of SiO₂ per 100% by mass of all the raw materials in terms of oxide.

When the mixture further contains the yttrium compound, the amount of the yttrium compound to be used is not particularly limited and may be 5% or less by mass in terms of Y₂O₃ per 100% by mass of all the raw materials in terms of oxide. More preferably, the amount of the yttrium compound to be mixed may range from 0.01% to 3% by mass in terms of Y₂O₃ per 100% by mass of all the raw materials in terms of oxide. To more suitably grow crystals, more preferably, the amount of the yttrium compound to be mixed may range from 0.1% to 1% by mass in terms of Y₂O₃ per 100% by mass of all the raw materials in terms of oxide.

When a molybdenum compound and a potassium compound are used as a flux, through the step of firing the aluminum compound in the presence of the molybdenum compound and the potassium compound and at least one shape control agent selected from silicon, silicon compounds, and germanium compounds, alumina particles with the card-house structure thus produced can easily contain silicon and/or germanium localized on and near the surface of plate-like alumina particles. According to the findings of the present inventors, the use of at least one shape control agent selected from silicon, silicon compounds, and germanium compounds in preparation is an important factor for easily forming the card-house structure, and silicon and/or germanium localized on and near the surface of alumina particles formed by firing is also an important factor that causes a great change in the surface state of alumina, which originally has few active sites, and not only makes the most of the good characteristics of alumina by itself but also makes it possible to impart a better surface state together with a surface treatment agent through a reaction at the active sites serving as starting points.

### [Firing Step]

The firing step is suitably the step of firing an aluminum compound in the presence of a molybdenum compound, at least one shape control agent selected from silicon, silicon compounds, and germanium compounds, and optionally another shape control agent. The firing step may also be the step of firing a mixture prepared in the mixing step.

The alumina particles are produced, for example, by firing an aluminum compound in the presence of a molybdenum compound and a shape control agent. As described above, this production method is referred to as the flux method. It is assumed based on the flux method that the formation of plate-like alumina particles and the formation of a card-house structure by the adhesion of three or more plate-like alumina particles proceed in parallel.

The flux method is classified as a solution method. More specifically, the flux method is a crystal growth method that utilizes a crystal-flux two-component phase diagram of a eutectic type. The flux method probably has the following mechanism. As a mixture of a solute and a flux is heated, the solute and flux become a liquid phase. The flux is a fusing agent, in other words, the solute-flux two-component phase diagram is of a eutectic type, and therefore the solute melts at a temperature lower than its melting point and constitutes a liquid phase. Evaporation of the flux in this state decreases the concentration of the flux or reduces the effect of the flux on lowering the melting point of the solute and causes as a driving force the crystal growth of the solute (a flux evaporation method). Crystal growth in the flux of the liquid phase is also a preferred method, and the solute and flux in the liquid phase can also be cooled to cause the crystal growth of the solute (a slow cooling method).

The flux method can advantageously grow crystals at a temperature much lower than the melting point, precisely control the crystal structure, and form automorphic polyhedral crystals.

In the production of alumina particles by the flux method using a molybdenum compound as a flux, although the mechanism is not entirely clear, for example, the following mechanism is assumed. Firing the aluminum compound in the presence of the molybdenum compound first forms aluminum molybdate. The aluminum molybdate grows alumina crystals at a temperature lower than the melting point of alumina, as can be understood from the above description. The aluminum molybdate is decomposed, for example, by evaporating the flux, grows crystals, and forms alumina particles. Thus, the molybdenum compound functions as a flux and forms alumina particles through the aluminum molybdate intermediate.

A combined use of a potassium compound and a shape control agent in the flux method makes it possible to efficiently produce the alumina particles with the card-house structure formed of three or more plate-like alumina particles. More specifically, a molybdenum compound and a potassium compound used in combination first react and form potassium molybdate. Simultaneously, the molybdenum compound reacts with an aluminum compound and forms aluminum molybdate. The aluminum molybdate is decomposed, for example, in the presence of the potassium molybdate, grows crystals in the presence of a shape control agent, and forms the alumina particles with the card-house structure formed of three or more plate-like alumina particles. Thus, in the production of the alumina particles via the aluminum molybdate intermediate, the alumina particles with the card-house structure formed of three or more plate-like alumina particles can be formed in the presence of potassium molybdate.

As described above, potassium or a potassium compound plays a role of a flux as potassium molybdate.

It should be noted that the above mechanism is merely speculative, and another mechanism that can provide the advantages of the present invention is also within the technical scope of the present invention.

The potassium molybdate may have any composition and typically contains a molybdenum atom, a potassium atom, and an oxygen atom. The structural formula is preferably represented by K₂MoₙO₃ₙ₊₁. The n is preferably, but not limited to, in the range of 1 to 3 because the growth of alumina particles is effectively promoted. The potassium molybdate may contain other atoms, such as sodium, magnesium, and silicon.

In one embodiment of the present invention, the firing may be performed in the presence of a metal compound. Thus, in the firing, the metal compound is used in combination with a molybdenum compound and a potassium compound. This can produce alumina particles with higher flowability.

Although the mechanism is not entirely clear, for example, the following mechanism is assumed. A metal compound present during the crystal growth of the alumina particles performs the function of preventing or suppressing the excessive formation of the alumina crystal nuclei and/or promoting the diffusion of an aluminum compound necessary for the growth of alumina crystals, in other words, preventing the excessive formation of crystal nuclei and/or increasing the diffusion rate of the aluminum compound, can more precisely control the growth direction of alumina crystals, facilitates shape control, for example, reflecting the shape of the precursor, and can provide alumina particles with higher flowability. It should be noted that the above mechanism is merely speculative, and another mechanism that can provide the advantages of the present invention is also within the technical scope of the present invention.

The firing may be performed by any method, including a traditional method. At a firing temperature of more than 700° C., an aluminum compound and a molybdenum compound react and form aluminum molybdate. At a firing temperature of 900° C. or more, aluminum molybdate is decomposed and forms plate-like alumina particles by the action of a shape control agent. The plate-like alumina particles are formed by introducing molybdenum into aluminum oxide particles when aluminum molybdate is decomposed into alumina and molybdenum oxide.

In firing, an aluminum compound, a shape control agent, a molybdenum compound, and a potassium compound may be in any state, provided that the molybdenum compound, the potassium compound, and the shape control agent are present close to each other to act on the aluminum compound. More specifically, a molybdenum compound powder, a shape control agent powder, and an aluminum compound powder may be simply mixed, may be mechanically mixed in a pulverizer, may be mixed in a mortar, or may be mixed in a dry state or a wet state.

The firing temperature conditions are not particularly limited and depend on the average particle size, flowability, and dispersibility of desired alumina particles and the aspect ratio of plate-like alumina particles. The maximum firing temperature is typically equal to or higher than 900° C., which is the decomposition temperature of aluminum molybdate (Al₂(MoO₄)₃).

In general, firing at a high temperature of 2000° C. or more, which is close to the melting point of α-alumina, is required to control the shape of α-alumina after firing. From the perspective of a heavy load on the firing furnace and fuel costs, however, there is significant problems in industrial applications.

Although the above suitable method for producing alumina particles can be performed even at high temperatures of more than 2000° C., alumina particles formed of plate-like alumina particles with a high α crystallinity and a high aspect ratio can be formed even at a temperature of 1600° C. or less, which is much lower than the melting point of α-alumina.

Alumina particles having plate-like alumina particles with a high aspect ratio and having an α crystallinity of 90% or more can be simply and efficiently formed at low cost by such a suitable production method even at a maximum firing temperature in the range of 900° C. to 1600° C. The maximum firing temperature preferably ranges from 920° C. to 1500° C., most preferably 950° C. to 1400° C.

A higher firing temperature results in improved α crystallization of an intersecting portion of plate-like alumina particles in the same manner as in the other portions. Thus, the resulting alumina particles with the card-house structure have high mechanical strength.

With respect to the firing time, the heat-up time to a predetermined maximum temperature preferably ranges from 15 minutes to 10 hours, and the holding time at the maximum firing temperature preferably ranges from 5 minutes to 30 hours. To efficiently form plate-like alumina particles, the firing holding time preferably ranges from 10 minutes to 15 hours.

A longer holding time at the maximum firing temperature results in improved α crystallization of an intersecting portion of plate-like alumina particles in the same manner as in the other portions. Thus, the resulting alumina particles with the card-house structure have high crushing strength.

The firing atmosphere is not particularly limited, provided that the advantages of the present invention are achieved, and is preferably, for example, an oxygen-containing atmosphere, such as air or oxygen, or an inert atmosphere, such as nitrogen or argon, more preferably an air atmosphere in terms of cost.

Any firing apparatuses, including so-called firing furnaces, may be used. The firing furnace is preferably made of a material that does not react with sublimed molybdenum oxide. Furthermore, to efficiently utilize molybdenum oxide, a firing furnace with high sealing performance is preferably used. The firing furnace to be used may be a tunnel furnace, a roller-hearth furnace, a rotary kiln, or a muffle furnace.

In the suitable production method described above, alumina particles with the card-house structure are selectively formed, and a powder containing the alumina particles constituting 60% or more on a number basis is easily formed. Production by the above production method under more suitable conditions is preferred because it can more easily produce a powder containing, among the above alumina particles, alumina particles with the card-house structure constituting 80% or more on a number basis in which three or more plate-like alumina particles intersect and aggregate at two or more positions and the plane directions of the intersecting plates are randomly arranged.

### [Cooling Step]

When a molybdenum compound and a potassium compound are used as a flux, the method for producing alumina particles may include a cooling step. The cooling step includes cooling alumina that is crystal-grown in the firing step. More specifically, the cooling step may include cooling a composition containing alumina formed in the firing step and a liquid-phase flux.

The cooling rate is preferably, but not limited to, in the range of 1° C./h to 1000° C./h, more preferably 5° C./h to 500° C./h, still more preferably 50° C./h to 100° C./h. A cooling rate of 1° C./h or more is preferred because the production time can be shortened. A cooling rate of 1000° C./h or less is preferred because the firing chamber is rarely broken by heat shock and can be used for extended periods.

The cooling method is not particularly limited and may be natural cooling or may include the use of a cooling apparatus.

### (Post-Treatment Step)

A method for producing composite particles according to an embodiment may include a post-treatment step. The post-treatment step is a post-treatment step for the alumina particles with the card-house structure and is the step of removing the flux. The post-treatment step may be performed after the firing step, after the cooling step, or after the firing step and cooling step. The post-treatment step may be performed twice or more, if necessary.

The post-treatment method includes washing and high-temperature treatment. These may be combined.

The washing method may include, but is not limited to, removal by washing with water, aqueous ammonia, aqueous sodium hydroxide, or an aqueous acid.

The concentration and amount of water, aqueous ammonia, aqueous sodium hydroxide, or the aqueous acid to be used, a portion to be washed, and the washing time may be appropriately changed to control the molybdenum content.

The high-temperature treatment method may be a method of increasing the temperature to the sublimation point or boiling point of the flux or higher.

### [Grinding Step]

The fired product may be an aggregate of alumina particles and is sometimes not in a particle size range suitable for an embodiment. Thus, if necessary, the alumina particles may be ground to have a particle size range suitable for an embodiment.

The method for grinding the fired product may be, but is not limited to, a known grinding method, such as using a ball mill, a jaw crusher, a jet mill, a disk mill, Spectromill, a grinder, or a mixer mill.

### [Classification Step]

The alumina particles are preferably subjected to classification treatment to adjust the average particle size, to improve powder flowability, or to reduce the increase in viscosity when the alumina particles are blended with a binder to form a matrix.

The classification may be wet or dry classification, preferably dry classification in terms of productivity. The dry classification may be sieve classification or air classification utilizing the difference between centrifugal force and fluid drag. The air classification is preferred in terms of classification accuracy and may be performed with an airflow classifier utilizing the Coanda effect, a swirling airflow classifier, a forced vortex centrifugal classifier, or a semi-free vortex centrifugal classifier.

The grinding step and the classification step may be performed as required, for example, before and/or after an organic compound layer forming step described later. The average particle size of alumina particles thus produced can be adjusted, for example, by the presence or absence of grinding and/or classification or by the selection of the conditions. The average particle size of the alumina particles is closely related to the angle of repose. Even when the average particle size cannot be sufficiently adjusted only by the above production method and production conditions of the alumina particles themselves, the flowability of the alumina particles can be adjusted by changing the average particle size of the alumina particles (indirectly changing the angle of repose) by selecting the conditions for classification.

More specifically, for example, when there is no alumina particles with the card-house structure having a desired average particle size, alumina particles with a larger average particle size may be classified to form alumina particles with the card-house structure having a smaller average particle size, which have higher flowability than known alumina particles with the same average particle size.

### [Inorganic Covering Portion Forming Step]

Next, an inorganic covering portion containing a composite metal oxide is formed on the surface of plate-like alumina particles constituting alumina particles with the card-house structure thus formed. Any layer forming method, for example, a liquid phase method or a gas phase method, may be used.

Any inorganic chemical species as described above may be used to form the inorganic covering portion.

In the inorganic covering portion forming step, for example, the plate-like alumina particles may be brought into contact with a metal inorganic salt containing at least one metal other than aluminum (Al) to convert the metal inorganic salt precipitated on the plate-like alumina particles into a composite metal oxide.

Alternatively, the plate-like alumina particles may be brought into contact with a first metal inorganic salt containing at least one metal other than aluminum (Al) to convert the first metal inorganic salt precipitated on the plate-like alumina particles into a metal oxide or a composite metal oxide (hereinafter also referred to simply as a “metal oxide or the like”) (a first conversion step), and then the metal oxide or the like and/or plate-like alumina particles may be brought into contact with a second metal inorganic salt containing at least one other metal other than aluminum (Al) and different from the metal used in the first conversion step to convert the metal oxide and/or the second metal inorganic salt into a composite metal oxide (a second conversion step).

Although a liquid medium dispersion of alumina particles containing molybdenum and a composite metal oxide itself or a dispersion liquid thereof may be mixed together, filtered, and dried to form a metal oxide covering portion on alumina particles, when it is desirable to enhance the interaction between the alumina particles and the composite metal oxide to achieve particularly excellent characteristics, such as to achieve better covering characteristics, to form a more uniform inorganic covering portion, or to make it difficult to separate the inorganic covering portion from the alumina particles, as described above, it is preferable to mix a solution of a first metal inorganic salt soluble in a liquid medium, which corresponds to a metal oxide precursor, with alumina particles containing molybdenum or a liquid medium dispersion thereof to sufficiently bring the dissolved molecular first metal inorganic salt into contact with the alumina particles containing molybdenum and then to convert a 150-nm or less fine first metal inorganic salt precipitated on the alumina particles into a metal oxide or the like. It is also preferable to mix a solution of a second metal inorganic salt soluble in a liquid medium with the alumina particles on which the metal oxide or the like is formed or a liquid medium dispersion thereof to sufficiently bring the dissolved molecular second metal inorganic salt and/or the alumina particles containing molybdenum into contact with the metal oxide or the like, thereby converting the metal oxide and/or a 150-nm or less fine second metal inorganic salt precipitated on the metal oxide or the like into a metal oxide or the like. If necessary, filtration and drying may also be performed. To convert the first metal inorganic salt into a metal oxide or the like or to convert the second metal inorganic salt into a metal oxide or the like, firing may be performed as required when the conversion is difficult due to low temperatures or pH changes. This can produce a strong interaction between the alumina particles and the composite metal oxide, which is not produced in a simple mixture, and can easily achieve the particularly excellent characteristics. The optimum firing conditions in the inorganic covering portion forming step may be appropriately selected and adopted with reference to the conditions for the alumina particles.

The firing conditions for converting the first metal inorganic salt into a metal oxide or the like may include a firing temperature, for example, in the range of 600° C. to 1200° C. The firing conditions for converting the second metal inorganic salt into a metal oxide or the like may include a firing temperature, for example, in the range of 600° C. to 1200° C. The first metal inorganic salt may be converted into a metal oxide simultaneously with the second inorganic salt, for example, by firing at 600° C. to 1200° C.

In the liquid phase method, for example, a dispersion liquid in which alumina particles are dispersed is prepared and is, if necessary, adjusted with respect to its pH and heated, and then an aqueous solution of a metal chloride, such as cobalt sulfate, is added dropwise to the dispersion liquid. The pH is preferably kept constant with an alkaline aqueous solution. The dispersion liquid is then stirred for a predetermined time, filtered, washed, and dried to produce a powder. Thus, the first inorganic covering portion formed of the metal sulfide, such as cobalt oxide, is formed on the surface of the plate-like alumina particles constituting the card-house structure.

Next, a dispersion liquid containing dispersed plate-like alumina particles on which the first inorganic covering portion is formed is prepared and is, if necessary, adjusted with respect to its pH and heated, and then an aqueous solution of a second metal chloride, such as iron chloride, is added dropwise to the dispersion liquid. The pH is preferably kept constant with an aqueous acid. The dispersion liquid is then stirred for a predetermined time, filtered, washed, and dried to produce a powder. Thus, a second inorganic covering portion formed of aluminum·cobalt oxide and iron oxide is formed on the surface of the plate-like alumina particles.

The inorganic covering portion may be formed of another composite metal oxide, such as aluminum·cobalt oxide, aluminum·zinc oxide, zinc·iron oxide and zinc oxide, or nickel·titanium oxide and nickel oxide. The inorganic covering portion may also be formed of nickel·iron oxide, nickel oxide and iron oxide, zinc-titanium oxide, cobalt·iron oxide and aluminum·cobalt oxide, or titanium·cobalt oxide and aluminum·cobalt oxide.

In this step, an inorganic covering layer may also be formed to cover at least part of the surface of plate-like alumina particles. In such a case, for example, particles composed of a composite metal oxide aggregate and form a layer.

### [Organic Compound Layer Forming Step]

In one embodiment, the method for producing composite particles may further include an organic compound layer forming step of forming an organic compound layer on the surface of the inorganic covering layer (also referred to as a composite particle surface) after the inorganic covering portion forming step. If necessary, the organic compound layer forming step is performed at a temperature at which the organic compound is not decomposed typically after the firing step or the post-treatment step.

The organic compound layer may be formed on the surface of composite particles by any method, including a known method. For example, a solution or dispersion liquid containing an organic compound is brought into contact with composite particles and is dried.

The organic compound for use in the formation of the organic compound layer may be an organosilane compound.

### [Organosilane Compound]

Alumina particles with the card-house structure containing a silicon atom and/or an inorganic silicon compound are more likely to have the surface modification effect as described above than alumina particles without the silicon atom and the inorganic silicon compound. It is also possible to use a reaction product of an organosilane compound and alumina particles containing a silicon atom and/or an inorganic silicon compound. Alumina particles with the card-house structure that are a reaction product of an organosilane compound and alumina particles with the card-house structure containing a silicon atom and/or an inorganic silicon compound are preferred to the alumina particles with the card-house structure containing a silicon atom and/or an inorganic silicon compound because the former alumina particles can have a higher affinity for the matrix due to the reaction between the organosilane compound and the silicon atom and/or the inorganic silicon compound localized on the surface of plate-like alumina particles constituting the alumina particles.

Examples of the organosilane compound include alkyl trimethoxysilanes and alkyl trichlorosilanes with an alkyl group having 1 to 22 carbon atoms, such as methyltrimethoxysilane, dimethyldimethoxysilane, ethyltrimethoxysilane, ethyltriethoxysilane, n-propyltrimethoxysilane, n-propyltriethoxysilane, iso-propyltrimethoxysilane, iso-propyltriethoxysilane, pentyltrimethoxysilane, and hexyltrimethoxysilane, 3,3,3-trifluoropropyltrimethoxysilane, tridecafluoro-1,1,2,2-tetrahydrooctyl)trichlorosilanes, phenyltrimethoxysilane, phenyltriethoxysilane, p-chloromethylphenyltrimethoxysilane, p-chloromethylphenyltriethoxysilanes, epoxy silanes, such as γ-glycidoxypropyltrimethoxysilane, γ-glycidoxypropyltriethoxysilane, and β-(3,4-epoxycyclohexyl)ethyltrimethoxysilane, aminosilanes, such as γ-aminopropyltriethoxysilane, N-β(aminoethyl)γ-aminopropyltrimethoxysilane, N-(aminoethyl)γ-aminopropylmethyldimethoxysilane, γ-aminopropyltrimethoxysilane, and γ-ureidopropyltriethoxysilane, mercaptosilanes, such as 3-mercaptopropyltrimethoxysilane, vinylsilanes, such as p-styryltrimethoxysilane, vinyltrichlorosilane, vinyl tris(β-methoxyethoxy)silane, vinyltrimethoxysilane, vinyltriethoxysilane, and γ-methacryloxypropyltrimethoxysilane, and epoxy, amino, and vinyl polymer type silanes. These organosilane compounds may be used alone or in combination.

The organosilane compound is covalently bonded by a reaction to at least part or all of the silicon atoms and/or the inorganic silicon compound on the surface of plate-like alumina particles of the alumina particles. The alumina particles may be partly or entirely covered with the reaction product. The alumina surface may be covered by immersion and deposition or by chemical vapor deposition (CVD).

The amount of organosilane compound to be used in terms of silicon atom is preferably 20% or less by mass, more preferably 10% to 0.01% by mass, of the mass of silicon atoms or inorganic silicon compound contained in the surface of plate-like alumina particles of the alumina particles. The amount of organosilane compound to be used is preferably 20% or less by mass because it is easy to exhibit the physical properties originating from the alumina particles.

A reaction between an organosilane compound and alumina particles containing a silicon atom and/or an inorganic silicon compound may be performed by a traditional surface modification method for filler, for example, a spray method using a fluid nozzle, a dry method, such as agitation with high shear force, a ball mill, or a mixer, or a wet method, such as an aqueous or organic solvent system. It is desirable that treatment using shear force be performed such that alumina particles used in an embodiment are not broken.

The system temperature in the dry method or the drying temperature after treatment in the wet method depends on the type of organosilane compound and is appropriately determined in the range where the organosilane compound is not thermally decomposed. For example, it is desirable that the temperature in treatment with the organosilane compound as described above be in the range of 80° C. to 150° C.

### (Post-Treatment Step)

The method for producing composite particles may further include an optional step in the middle of the production of the composite particles or a post-treatment step after the inorganic covering portion forming step to adjust the particle size, shape, or the like as required, provided that the effects of the method are not impaired. Examples of such a step include granulation steps, such as tumbling granulation and compression granulation, and granulation by a spray-drying method using a binding agent as a binder. These can be easily performed using commercial equipment.

### EXAMPLES

Although the present invention is described in more detail in the following examples, the present invention is not limited to these examples.

### Example 1

First, card-house type alumina particles to be used as the base of composite particles were produced. 146.15 g of aluminum hydroxide (94.1% by mass in terms of Al₂O₃) (manufactured by Nippon Light Metal Co., Ltd., average particle size: 60 μm), 5 g of molybdenum trioxide (5% by mass in terms of MoO₃) (manufactured by Taiyo Koko Co., Ltd.), and 0.95 g of silicon dioxide (0.9% by mass in terms of SiO₂) (manufactured by Kanto Chemical Co., Inc., special grade) were mixed in a mortar to prepare a mixture. The mixture was put into a crucible and was fired in a ceramic electric furnace at a heating rate of 5° C./min and at a holding temperature of 1100° C. for a holding time of 10 hours. The crucible was cooled to room temperature at a cooling rate of 5° C./min and was removed, and 105.0 g of a light blue powder was produced. The powder was ground in a mortar so that the powder could pass through a 106-μm sieve.

Subsequently, 100 g of the light blue powder was dispersed in 150 mL of 0.5% aqueous ammonia, and the dispersion solution was stirred at room temperature (25° C. to 30° C.) for 0.5 hours. The aqueous ammonia was removed by filtration, and molybdenum remaining on the particle surface was removed by washing with water and drying. Thus, 98 g of a powder was produced. Subsequently, fine particle components were removed by classification with an airflow classifier utilizing the Coanda effect (Hiprec classifier HPC-ZERO manufactured by Powder Systems Corporation). Thus, 65 g of an alumina particle powder was produced. A measurement of zeta potential showed that the alumina particles had an isoelectric point of pH 5.3.

SEM observation showed that the powder was composed of alumina particles with the card-house structure formed of three or more plate-like alumina particles that adhere to each other (FIG. 1). The powder had an average particle size of 55 μm. The plate-like alumina particles constituting the card-house structure had a polygonal-plate-like shape and had a thickness D of 0.4 μm, a maximum diameter L of 9 μm, and an aspect ratio of 23. XRD measurement showed a sharp scattering peak originating from α-alumina and no alumina crystal system peak other than the α crystal structure. The fluorescent X-ray quantitative analysis (XRF) showed that the particles contained 0.79% by mass of molybdenum in terms of molybdenum trioxide, and the concentration ratio [Si]/[Al] (mole ratio) of Si to Al was 0.74%.

Next, 5 g of card-house type alumina particles were dispersed in 50 mL of water to prepare a dispersion liquid. The pH of the dispersion liquid was adjusted to pH 11.4 with 1 mol of NaOH, and simultaneously the temperature of the dispersion liquid was adjusted to 65° C. While the dispersion liquid was stirred, 14.8 g of 14.1% aqueous CoSO₄ was added dropwise for 2.1 hours. Simultaneously, the dispersion liquid was maintained at pH 11.4 using 24.9 g of 5% aqueous NaOH. After the aqueous CoSO₄ was added dropwise, the dispersion liquid was stirred for another 4 hours, was filtered, was washed with water, and was then dried at 1200° C. for 2 hours. Thus, 5.45 g of a sample of card-house type composite particles covered with aluminum·cobalt oxide was produced. The card-house type composite particles had a BET specific surface area of 1.2 m²/g. The composite particles were blue.

### Example 2

5 g of the card-house type alumina particles produced in Example 1 were dispersed in 50 mL of water to prepare a dispersion liquid. The pH of the dispersion liquid was adjusted to pH 11.4 with 1 mol of NaOH, and simultaneously the temperature of the dispersion liquid was adjusted to 65° C. While the dispersion liquid was stirred, 14.8 g of 14.1% aqueous CoSO₄ was added dropwise for 2.1 hours. Simultaneously, the dispersion liquid was maintained at pH 11.4 using 24.9 g of 5% aqueous NaOH. After the aqueous CoSO₄ was added dropwise, the dispersion liquid was stirred for another 4 hours, was filtered, was washed with water, and was then dried at 1200° C. for 2 hours. Thus, 5.40 g of a powder of plate-like alumina particles covered with a first layer formed of cobalt oxide was produced.

Furthermore, 5 g of the powder was dispersed in 50 mL of water to prepare a dispersion liquid. The pH of the dispersion liquid was adjusted to pH 2.7 with 1 mol of HCl, and simultaneously the temperature of the dispersion liquid was adjusted to 75° C. While the dispersion liquid was stirred, 13.9 g of 8.1% aqueous FeCl₃ was added dropwise for 2 hours. Simultaneously, the dispersion liquid was maintained at pH 2.7 using 16.8 g of 5% aqueous NaOH. After the aqueous FeCl₃ was added dropwise, the dispersion liquid was stirred for another 4 hours, was filtered, was washed with water, and was then dried at 700° C. for 2 hours. Thus, 5.2 g of a sample of card-house type composite particles covered with aluminum·cobalt oxide and iron oxide (III) was produced. The card-house type composite particles had a BET specific surface area of 0.9 m²/g. The composite particles were black.

### Example 3

5.36 g of a sample of card-house type composite particles covered with cobalt·iron oxide and aluminum·cobalt oxide was produced in the same manner as in Example 2 except that 93.8 g of an 8.1% FeCl₃ solution was used to form the first layer, the FeCl₃ solution was added dropwise for 4.5 hours or less, 11.9 g of aqueous NaOH was used to maintain the dispersion liquid at pH 2.7, a CoSO₄ solution was used to form a second layer, 14.8 g of a 14.1% CoSO₄ solution was added dropwise for 2.1 hours or less, and 112.5 g of aqueous NaOH was used to maintain the dispersion liquid at pH 1.8. The card-house type composite particles had a BET specific surface area of 1.7 m²/g. The composite particles were black.

### Example 4

5.4 g of a sample of card-house type composite particles covered with nickel·iron oxide, nickel oxide, and iron oxide (III) was produced in the same manner as in Example 3 except that a NiCl₂ solution was used to form the second layer, an 11.9% NiCl₂ solution was added dropwise for 2 hours or less, and 23.8 g of aqueous NaOH was used to maintain the dispersion liquid at pH 11.4. The card-house type composite particles had a BET specific surface area of 2.0 m²/g. The composite particles were dark brown.

### Example 5

5.5 g of a sample of card-house type composite particles covered with zinc·iron oxide and zinc oxide was produced in the same manner as in Example 3 except that 15.6 g of an 11.9% ZnCl₂ solution was used to form the second layer, and the ZnCl₂ solution was added dropwise for 2 hours or less. The card-house type composite particles had a BET specific surface area of 1.5 m²/g. The composite particles were brown.

### Example 6

5.5 g of a sample of card-house type composite particles covered with zinc-titanium oxide was produced in the same manner as in Example 2 except that 178.1 g of a 5% TiCl₄ solution was used to form the first layer, the TiCl₄ solution was added dropwise for 2 hours or less, 330.5 g of aqueous NaOH was used to maintain the dispersion liquid at pH 1.8, 15.6 g of an 11.9% ZnCl₂ solution was used to form the second layer, and the ZnCl₂ solution was added dropwise for 2 hours or less. The card-house type composite particles had a BET specific surface area of 1.1 m²/g. The composite particles were white.

### Example 7

5.4 g of a sample of card-house type composite particles covered with nickel·titanium oxide and nickel oxide was produced in the same manner as in Example 6 except that 29.7 g of an 11.9% NiCl₂ solution was used to form the second layer, the NiCl₂ solution was added dropwise for 2 hours or less, and 23.8 g of aqueous NaOH was used to maintain the dispersion liquid at pH 7. The card-house type composite particles had a BET specific surface area of 1.9 m²/g. The composite particles were yellow-green.

### Example 8

5.5 g of a sample of card-house type composite particles covered with titanium·cobalt oxide and aluminum·cobalt oxide was produced in the same manner as in Example 6 except that 14.8 g of a 14.1% CoSO₄ solution was used to form the second layer, the CoSO₄ solution was added dropwise for 2.1 hours or less, and 11.9 g of aqueous NaOH was used to maintain the dispersion liquid at pH 7. The card-house type composite particles had a BET specific surface area of 1.1 m²/g. The composite particles were dark green.

### Example 9

5.3 g of a sample of card-house type composite particles covered with aluminum·zinc oxide was produced in the same manner as in Example 1 except that 15.6 g of an 11.9% ZnCl₂ solution was used to form the first layer, the ZnCl₂ solution was added dropwise for 2.1 hours or less, and 23.0 g of aqueous NaOH was used to maintain the dispersion liquid at pH 7. The card-house type composite particles had a BET specific surface area of 1.3 m²/g. The composite particles were white.

### Comparative Example 1

Plate-like alumina particles to be used as the base of composite particles were produced. 100 g of commercial aluminum hydroxide (average particle size: 1 to 2 μm) (65% by mass in terms of Al₂O₃), 6.5 g of molybdenum trioxide (manufactured by Taiyo Koko Co., Ltd.) (9.0% by mass in terms of MoO₃), and 0.65 g of silicon dioxide (manufactured by Kanto Chemical Co., Inc., special grade) (0.9% by mass in terms of SiO₂) were mixed in a mortar to prepare a mixture. The mixture was put into a crucible, was heated in a ceramic electric furnace to 1200° C. at 5° C./min, and was fired at 1200° C. for 10 hours. The crucible was then cooled to room temperature at 5° C./min and was removed, and 67.0 g of a light blue powder was produced. The powder was ground in a mortar so that the powder could pass through a 2-mm sieve.

Subsequently, 5.0 g of the light blue powder was dispersed in 150 mL of 0.5% aqueous ammonia, and the dispersion solution was stirred at room temperature (25° C. to 30° C.) for 0.5 hours. The aqueous ammonia was removed by filtration, and molybdenum remaining on the particle surface was removed by washing with water and drying. Thus, 60.0 g of a light blue powder was produced.

SEM observation showed that the powder was polygonal and had a thickness of 0.5 μm, an average particle size of 28 μm, and an aspect ratio of 32.5. SEM observation also showed plate-like particles without twin crystals or without aggregates composed of overlapping plates, which suggest dispersion. XRD measurement showed a sharp scattering peak originating from α-alumina and no alumina crystal system peak other than the α crystal structure. The fluorescent X-ray quantitative analysis showed that the particles contained 0.61% by mass of molybdenum in terms of molybdenum trioxide, and the concentration ratio [Si]/[Al](mole ratio) of Si to Al was 0.07.

5.5 g of a sample of plate-like alumina particles covered with aluminum·cobalt oxide and iron oxide (III) was produced in the same manner as in Example 2 except that plate-like alumina particles were used. The composite particles were black.

### Comparative Example 2

5.5 g of a sample of plate-like alumina particles covered with zinc·iron oxide and zinc oxide was produced in the same manner as in Example 5 except that the plate-like alumina particles of Comparative Example 1 were used. The composite particles were brown.

TABLE 1

| | | Example 1 | Example 2 | Example 3 | Example 4 | Example 5 |
|---|---|---|---|---|---|---|
| Alumina | Shape | Card-house type | | | | |
| particles | D₅₀(μ) | 55 | | | | |
| First layer | Covering material | CoO | CoO | Fe₂O₃ | Fe₂O₃ | Fe₂O₃ |
| covering | CoSO₄•7H₂O solution drop | 2.1 | 2.1 | | | |
| conditions | time (h) | | | | | |
| | FeCl₃ solution drop time (h) | | | 4.5 | 4.5 | 4.5 |
| | TiCl₄ solution drop time (h) | | | | | |
| | ZnCl₂ solution drop time (h) | | | | | |
| | Temperature | 65 | 65 | 75 | 75 | 75 |
| | pH | 11.4 | 11.4 | 2.7 | 2.7 | 2.7 |
| | Firing time (h, 1200° C.) | 2 | 2 | | | |
| Second | Covering material | | Fe₂O₃ | CoO | NiO | ZnO |
| layer | CoSO₄•7H₂O solution drop | | | 2.1 | | |
| covering | time (h) | | | | | |
| condition | FeCl₃ solution drop time (h) | | 2 | | | |
| | NiCl₂•6H₂O solution drop | | | | 2 | |
| | time (h) | | | | | |
| | ZnCl₂ solution drop time (h) | | | | | 2 |
| | Temperature (° C.) | | 75 | 70 | 65 | 70 |
| | pH | | 2.7 | 1.8 | 11.4 | 1.8 |
| | Firing temperature (° C.) | | 700 | 700 | 700 | 700 |
| | Firing time (h) | | 2 | 2 | 2 | 2 |
| | Composition of inorganic | CoAl₂O₄ | CoAl₂O₄, | CoFe₂O₄, | NiFe₂O₄, | ZnFe₂O₄, |
| | covering layer determined | | Fe₂O₃ | Co₂AlO₄ | NiO, Fe₂O₃ | ZnO |
| | by XRD | | | | | |
| | Angle of repose | 35 | 39 | 36 | 35 | 37 |
| | Rating | Good | Good | Good | Good | Good |

TABLE 2

| | | Example | Example | Example | Example | Comparative | Comparative |
|---|---|---|---|---|---|---|---|
| | | 6 | 7 | 8 | 9 | Example 1 | Example 2 |
| Alumina | Shape | Card-house type | | | | Plate-like | |
| particles | D₅₀(μ) | 55 | | | | 28 | |
| First layer | Covering material | TiO₂ | TiO₂ | TiO₂ | ZnO | CoO | Fe₂O₃ |
| covering | CoSO₄•7H₂O solution | | | | | 2.1 | |
| condition | drop time (h) | | | | | | |
| | FeCl₃ solution drop time | | | | | | 4.5 |
| | (h) | | | | | | |
| | TiCl₄ solution drop time | 5.8 | 5.8 | 5.8 | | | |
| | (h) | | | | | | |
| | ZnCl₂ solution drop time | | | | 2.1 | | |
| | (h) | | | | | | |
| | Temperature | 70 | 70 | 70 | 60 | 65 | 75 |
| | pH | 1.8 | 1.8 | 1.8 | 7 | 11.4 | 2.7 |
| | Firing time (h, 1200° C.) | | | | 2 | 2 | |
| Second | Covering material | ZnO | NiO | CoO | | Fe₂O₃ | ZnO |
| layer | CoSO₄•7H₂O solution | | | 2.1 | | | |
| covering | drop time (h) | | | | | | |
| condition | FeCl₃ solution drop time | | | | | 2 | |
| | (h) | | | | | | |
| | NiCl₂•6H₂O solution drop | | 2 | | | | |
| | time (h) | | | | | | |
| | ZnCl₂ solution drop time | 2 | | | | | 2 |
| | (h) | | | | | | |
| | Temperature (° C.) | 60 | 60 | 60 | | 75 | 70 |
| | pH | 2.7 | 7 | 7 | | 2.7 | 1.8 |
| | Firing temperature (° C.) | 700 | 700 | 700 | | 700 | 700 |
| | Firing time (h) | 2 | 2 | 2 | | 2 | 2 |
| | Composition of inorganic | Zn₂TiO₄ | NiTiO₃, | CoTiO₃, | ZnAl₂O₄ | CoAl₂O₄, | ZnFe₂O₄, |
| | covering layer | | NiO | CoAl₂O₄ | | Fe₂O₃ | ZnO |
| | determined by XRD | | | | | | |
| | Angle of repose | 33 | 38 | 39 | 36 | 59 | 56 |
| | Rating | Good | Good | Good | Good | Poor | Poor |

### [Evaluation]

Each sample of the composite particle powders according to Examples 1 to 9 and Comparative Examples 1 and 2, the powders of alumina particles with the card-house structure according to Examples 1 to 9, and the plate-like alumina particle powders according to Comparative Examples 1 and 2 was subjected to the following evaluation. The measurement methods are described below.

[Shape Analysis of Composite Particles with Scanning Electron Microscope]

The sample was fixed to a sample support with a double-sided tape and was checked for the card-house structure of composite particles with a surface observation apparatus (VE-9800 manufactured by Keyence Corporation).

### [Composition Analysis of Card-House Type Alumina Particles by Fluorescent X-rays (XRF)]

Approximately 100 mg of the sample thus prepared was weighed on a filter paper, was covered with a PP film, and was subjected to a fluorescent X-ray (XRF) analyzer (Primus IV manufactured by Rigaku Corporation).

The [Si]/[Al] (mole ratio) determined by the XRF analysis was taken as the Si content of alumina particles.

The [Mo]/[Al] (mole ratio) determined by the XRF analysis was taken as the Mo content of alumina particles.

### [Measurement of Maximum Diameter L of Plate-Like Alumina Particles]

The maximum diameter L of plate-like alumina particles was determined by measuring the maximum length between two points on the contour of the plate with a scanning electron microscope (SEM) in 100 plate-like alumina particles in the center of alumina particles and calculating the arithmetic mean.

### [Measurement of Thickness D of Plate-Like Alumina Particles]

The thickness D (μm) was determined by measuring the thickness of 50 particles with a scanning electron microscope (SEM) and calculating the average.

### [Aspect Ratio L/D]

The aspect ratio was determined using the following equation.

(Aspect ratio)=(Maximum diameter L of plate-like alumina particles/Thickness D of plate-like alumina particles)

### [Measurement of Average Particle Size of Alumina Particles by Measurement of Particle Size Distribution]

The average particle size of card-house type alumina particles was determined as D₅₀ (μm) by measuring the volumetric cumulative particle size distribution of the sample with the laser diffraction dry particle size distribution analyzer under the above conditions.

### [Measurement of Powder Flowability]

The powder flowability was evaluated by preparing 300 g of the sample and measuring the angle of repose of the sample by a method according to JIS R9301-2-2. The value was obtained by rounding off the second decimal place to the first decimal place. An angle of repose of 50.0 degrees or less was rated good, and an angle of repose of more than 50.0 degrees was rated poor. Tables 1 and 2 show the evaluation results.

It was demonstrated that the powder produced in Example 1 had an inorganic covering portion on the surface of plate-like alumina particles constituting alumina particles with the card-house structure formed of three or more plate-like alumina particles that adhere to each other It was also demonstrated that the powders produced in Examples 2 to 9 had an inorganic covering portion on the surface of plate-like alumina particles as in Example 1.

By contrast, it was demonstrated that the composite particles in the powders produced in Comparative Examples 1 and 2 had a plate-like shape without twin crystals or without aggregates composed of overlapping plates.

SEM observation in Examples 1 to 9 and Comparative Examples 1 and 2 showed that the surface of plate-like alumina particles was covered with a particulate composite metal oxide shown in Tables 1 and 2.

FIGS. 1 to 3 show SEM images of the card-house type alumina particles of Example 2 as a representative. The magnification in FIGS. 1, 2, and 3 was 500, 2000, and 50000, respectively.

FIGS. 1 to 3 show that the surface of the plate-like alumina particles of Example 1 was covered with particulate aluminum·cobalt oxide (CoAl₂O₄) and titanium oxide (TiO₂).

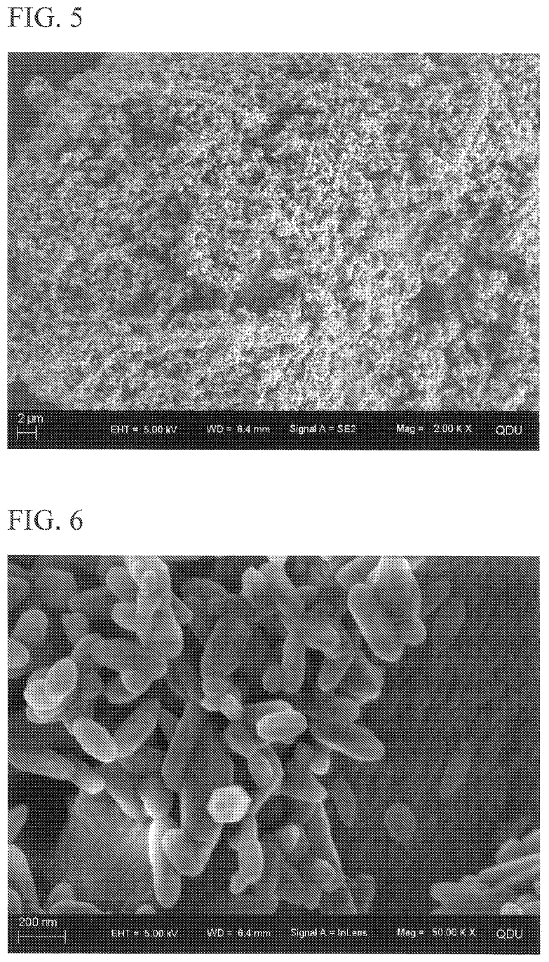

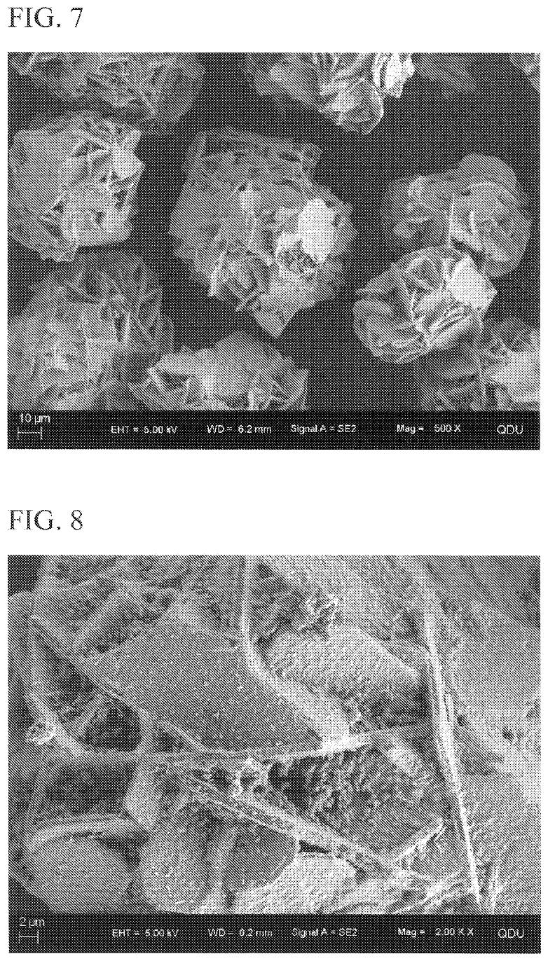

FIGS. 4 to 6 show electron microscope images of the card-house type alumina particles of Example 5. The magnification in FIGS. 4, 5, and 6 was 500, 2000, and 50000, respectively.

FIGS. 4 to 6 show that the surface of the plate-like alumina particles of Example 4 was covered with particulate zinc·iron oxide (ZnFe₂O₄) and zinc oxide (ZnO).

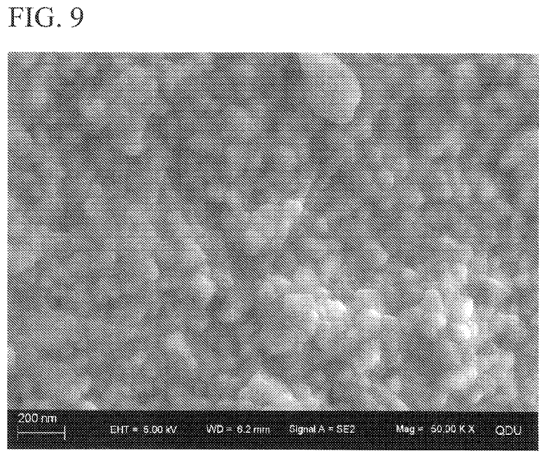

FIGS. 7 to 9 show electron microscope images of the card-house type alumina particles of Example 6. The magnification in FIGS. 7, 8, and 9 was 500, 2000, and 50000, respectively.

FIGS. 7 to 9 show that the surface of the plate-like alumina particles of Example 5 was covered with particulate zinc-titanium oxide.

The card-house type composite particles of Example 1, in which the CoSO₄ solution was added dropwise for 2.1 hours to form the inorganic covering portion formed of the aluminum·cobalt oxide, had an angle of repose of 35 degrees, which indicates high flowability.

The card-house type composite particles of Example 2, in which the CoSO₄ solution was added dropwise for 2.1 hours and the FeCl₃ solution was added dropwise for 2 hours to form the inorganic covering portion formed of the aluminum·cobalt oxide and iron oxide (III), had an angle of repose of 39 degrees, which indicates high flowability.

The card-house type composite particles of Example 3, in which the FeCl₃ solution was added dropwise for 4.5 hours and the CoSO₄ solution was added dropwise for 2.1 hours to form the inorganic covering portion formed of the cobalt·iron oxide and aluminum·cobalt oxide, had an angle of repose of 36 degrees, which indicates high flowability.

The card-house type composite particles of Example 4, in which the FeCl₃ solution was added dropwise for 4.5 hours and the NiCl₂ solution was added dropwise for 2 hours to form the inorganic covering portion formed of the nickel·iron oxide, nickel oxide, and iron oxide (III), had an angle of repose of 35 degrees, which indicates high flowability.

The card-house type composite particles of Example 5, in which the FeCl₃ solution was added dropwise for 4.5 hours and the ZnCl₂ solution was added dropwise for 2 hours to form the inorganic covering portion formed of the zinc·iron oxide and zinc oxide, had an angle of repose of 37 degrees, which indicates high flowability.

The card-house type composite particles of Example 6, in which the TiCl₄ solution was added dropwise for 5.8 hours and the ZnCl₂ solution was added dropwise for 2 hours to form the inorganic covering portion formed of the zinc-titanium oxide, had an angle of repose of 33 degrees, which indicates high flowability.

The card-house type composite particles of Example 7, in which the TiCl₄ solution was added dropwise for 5.8 hours and the NiCl₂ solution was added dropwise for 2 hours to form the inorganic covering portion formed of the nickel·titanium oxide and nickel oxide, had an angle of repose of 38 degrees, which indicates high flowability.

The card-house type composite particles of Example 8, in which the TiCl₄ solution was added dropwise for 5.8 hours and the CoSO₄ solution was added dropwise for 2.1 hours to form the inorganic covering portion formed of the titanium·cobalt oxide and aluminum·cobalt oxide, had an angle of repose of 39 degrees, which indicates high flowability.

The card-house type composite particles of Example 9, in which the ZnCl₂ solution was added dropwise for 2.1 hours to form the inorganic covering portion formed of the aluminum·zinc oxide, had an angle of repose of 36 degrees, which indicates high flowability.

By contrast, the composite particles of Comparative Example 1, in which the plate-like alumina particles had D₅₀ of 28 μm, a thickness D of 0.5 μm, and an aspect ratio of 32.5, and the CoSO₄ solution was added dropwise for 2.1 hours and the FeCl₃ solution was added dropwise for 2 hours to form the inorganic covering portion formed of the aluminum·cobalt oxide and iron oxide (III), had an angle of repose of 59 degrees, which is larger than the angles of repose of Examples 1 to 9 and indicates low flowability.

The composite particles of Comparative Example 2, in which the FeCl₃ solution was added dropwise for 4.5 hours and the ZnCl₂ solution was added dropwise for 2 hours to form the inorganic covering portion formed of the zinc·iron oxide and zinc oxide, had an angle of repose of 56 degrees, which is larger than the angles of repose of Examples 1 to 9 and indicates low flowability as in Comparative Example 1.

### INDUSTRIAL APPLICABILITY

Composite particles according to the present invention are expected to have high dispersibility and a high filling rate due to their high flowability and are therefore suitably used in base materials for thermally conductive fillers, cosmetics, abrasives, bright pigments, lubricants, and electrically conductive powders, and in ceramic materials.

1. Composite particles comprising:
alumina particles with a card-house structure formed of three or more plate-like alumina particles that adhere to each other; and
an inorganic covering portion located on a surface of the plate-like alumina particles and containing a composite metal oxide,
wherein the composite metal oxide contains a metal oxide of two or more metals selected from iron (Fe), titanium (Ti), zinc (Zn), nickel (Ni), cobalt (Co), and aluminum (Al).

2. The composite particles according to claim 1, wherein the alumina particles have an average particle size in the range of 3 to 1000 μm.

3. (canceled)

4. The composite particles according to claim 1, wherein the composite metal oxide contains a metal oxide of a metal selected from iron (Fe), titanium (Ti), zinc (Zn), nickel (Ni), and cobalt (Co) and another metal oxide different from the metal oxide, the other metal oxide being a metal oxide of a metal selected from iron (Fe), titanium (Ti), zinc (Zn), nickel(Ni), and cobalt (Co).

5. The composite particles according to claim 1, wherein the alumina particles further contain silicon (Si) and/or germanium(Ge).

6. The composite particles according to claim 5, wherein the alumina particles contain mullite in a surface layer.

7. The composite particles according to claim 1, wherein the composite particles have an angle of repose of 50 degrees or less.

8. A method for producing composite particles, comprising the steps of: firing a mixture containing an aluminum compound containing aluminum, a molybdenum compound containing molybdenum, and a shape control agent for controlling the shape of alumina particles to produce alumina particles with a card-house structure formed of three or more plate-like alumina particles that adhere to each other; and forming an inorganic covering portion containing a composite metal oxide on a surface of the plate-like alumina particles,
wherein the composite metal oxide contains a metal oxide of two or more metals selected from iron (Fe), titanium (Ti), zinc (Zn), nickel (Ni), cobalt (Co), and aluminum (Al).

9. The method for producing composite particles according to claim 8, wherein the shape control agent contains one or two or more selected from silicon, silicon compounds containing silicon, and germanium compounds containing germanium.

10. The method for producing composite particles according to claim 8, wherein the mixture contains a molybdenum compound containing molybdenum, the molybdenum constituting 10% or less by mass in terms of MoO₃ per 100% by mass of all raw materials in terms of oxide.

11. The method for producing composite particles according to claim 8, wherein the mixture contains an aluminum compound with an average particle size of 2 μm or more.

12. The method for producing composite particles according to claim 8, wherein the mixture further contains a potassium compound containing potassium.

13. (canceled)

14. The method for producing composite particles according to claim 8, wherein the composite metal oxide contains a metal oxide of a metal selected from iron (Fe), titanium (Ti), zinc (Zn), nickel (Ni), and cobalt (Co) and another metal oxide different from the metal oxide, the other metal oxide being a metal oxide of a metal selected from iron (Fe), titanium (Ti), zinc (Zn), nickel (Ni), and cobalt (Co).

15. The method for producing composite particles according to claim 8, wherein the step of forming the inorganic covering portion includes bringing the alumina particles into contact with a first metal inorganic salt containing at least one metal other than aluminum (Al) to convert a metal inorganic salt precipitated on the alumina particles into a composite metal oxide.

16. The method for producing composite particles according to claim 8, wherein
the step of forming the inorganic covering portion includes a first conversion step of bring the alumina particles into contact with a first metal inorganic salt containing at least one metal other than aluminum (Al) to convert the first metal inorganic salt precipitated on the alumina particles into a metal oxide, and
a second conversion step of bringing the metal oxide and/or the alumina particles into contact with a second metal inorganic salt containing at least one other metal other than aluminum (Al) and different from the metal used in the first conversion step to convert the metal oxide and/or the second metal inorganic salt into a composite metal oxide.

17. The method for producing composite particles according to claim 9, wherein the mixture further contains a potassium compound containing potassium.

18. The method for producing composite particles according to claim 10, wherein the mixture further contains a potassium compound containing potassium.

19. The method for producing composite particles according to claim 11, wherein the mixture further contains a potassium compound containing potassium.
